(19) United States
(12) Patent Application Publication
(10) Pub. No.: US 2024/0429559 A1
(43) Pub. Date: Dec. 26, 2024

(54) Multilayer Porous Membrane

(71) Applicant: ASAHI KASEI KABUSHIKI KAISHA, Tokyo (JP)

(72) Inventors: Wataru Mizutani, Tokyo (JP); Kazushi Funakoshi, Tokyo (JP); Haruka Yokoyama, Tokyo (JP)

(73) Assignee: ASAHI KASEI KABUSHIKI KAISHA, Tokyo (JP)

(21) Appl. No.: 18/618,866

(22) Filed: Mar. 27, 2024

(30) Foreign Application Priority Data
Mar. 29, 2023 (JP) 2023-053853

(51) Int. Cl. H01M 50/451; H01M 50/417; H01M 50/443; H01M 50/491

(52) U.S. Cl. CPC H01M 50/451; H01M 50/417; H01M 50/443; H01M 50/491

(57) ABSTRACT

The object of the disclosure is to provide a multilayer porous membrane that can improve heat resistance (ability to inhibit heat shrinkage) and strength when the thickness of a nonaqueous electrolyte solution battery separator has been decreased, while inhibiting friction on the separator surface as a whole, and that can also increase energy density in a nonaqueous electrolyte solution battery, as well as a nonaqueous electrolyte solution battery separator and a nonaqueous electrolyte solution battery comprising the same.

### FIELD

The present invention relates to a multilayer porous membrane, and more specifically it relates to a multilayer porous membrane that can be suitably used as a separator to be disposed between a positive electrode and negative electrode in a nonaqueous electrolyte solution battery.

### BACKGROUND

In a conventional nonaqueous electrolyte solution battery, a power generating element comprising a separator lying between a positive plate and negative plate is impregnated with an electrolyte solution. Separators are generally required to have ion permeability and to also exhibit safety, including a shutdown function, and therefore separators comprising microporous membranes with polyolefin resins have been used. Multilayer porous membranes or porous films having porous layers containing inorganic particles layered or coated on polyolefin microporous membranes have also been investigated for use as separators, from the viewpoint of electrical insulating properties during thermal runaway, and heat resistance, strength, nonaqueous electrolyte solution battery safety and cycle characteristics (PTLs 1 to 9).

PTLs 1 to 4 describe the frictional coefficients of porous layers, porous films or separators.

PTL 1 discloses a laminated porous film having a heat-resistant porous layer containing an inorganic filler and a resin binder layered over at least one side of a polyolefin resin porous film, wherein the surface static friction coefficient of the heat-resistant porous layer is 0.45 or lower, the air permeability is 2000 sec/100 cm³ or lower, the tensile modulus at 3% elongation in the lengthwise direction is 400 to 1000 MPa, the percentage of inorganic filler in the total amount of inorganic filler and resin binder is 92 weight % or greater, the mean particle size of the inorganic filler measured using a scanning electron microscope (SEM) is 0.1 to 3.0 μm, and the laminated porous film has β-crystal activity.

PTL 2 discloses a nonaqueous secondary battery separator comprising a polyolefin microporous membrane and, covering one or both sides thereof, a heat-resistant porous layer which includes a heat-resistant resin and an inorganic filler, wherein the static friction coefficient is 0.3 to 1.0, the difference in film thickness as measured using a contact film thickness meter in which the contact bottom is a circular contact terminal with a diameter of 0.5 cm, under applied loads of 36 g/cm² and 1.2 kg/cm 2, is 2.0 to 10 μm, the mean particle size of the inorganic filler is 0.1 to 1 μm and the thickness of the heat-resistant porous layer per side of the polyolefin microporous membrane is 3 to 12 μm.

PTL 3 discloses a porous film obtained by biaxial stretching of a non-porous membrane material laminate of a polypropylene-based resin-containing layer and a polyethylene-based resin-containing layer, wherein the static friction coefficient against the film is 0.5 or greater, the static friction coefficient against stainless steel (SUS) is less than 0.9, and the porous film has (3-crystal activity. The static friction coefficient against the film as described in PTL 3 is the largest numerical value from among the static friction coefficients determined by preparing two measuring porous films and performing measurement by sliding them against each other while stacked together front-to-front, front-to-back and back-to-back, while the static friction coefficient against SUS is the larger numerical value from among the static friction coefficients on the front side and back side, measured by sliding the front side or back side of a measuring porous film stacked against SUS.

PTL 4 discloses a nonaqueous electrolyte battery separator having a porous substrate and an adhesive porous layer including an adhesive resin and an inorganic filler formed on one or both sides of the porous substrate, wherein the surface dynamic friction coefficient of the adhesive porous layer is 0.1 to 0.6, the ten-point height of irregularities (Rz) is 1.0 μm to 8.0 μm, the mean particle size of the inorganic filler is 0.1 μm to 3.0 μm and the content ratio of the inorganic filler in the adhesive porous layer is 1 to 90 weight % with respect to the total solid content.

On the other hand, following PTLs 5 to 9 do not describe the frictional coefficients of porous layers, porous films or separators.

In PTL 5, for a secondary battery separator comprising a heat-resistant porous layer that includes barium sulfate particles and a synthetic resin binder formed on at least one side of a polyolefin porous film, administration is made to the mean particle size and volume ratio of the barium sulfate particles, the range of air permeability increase per 1 μm thickness of the heat-resistant porous layer with respect to the polyolefin porous film, and the heat shrinkage factor at 130° C. and hydrogen sulfide concentration of the secondary battery separator, so that the barium sulfate particles shield X-rays similar to electrode metal foils, thereby making it possible to observe positional deviation with respect to the electrodes in an X-ray examination step during production of the secondary battery, and also allowing barium sulfate particles with a relatively small mean particle size to fill the heat-resistant porous layer, thus reducing the water content while inhibiting heat shrinkage. With the secondary battery separator described in PTL 5, however, the synthetic resin binder is not suited for barium sulfate particles which have a small mean particle size, making it necessary to use a relatively large amount of synthetic resin binder to increase the heat resistance, and it is therefore in need of improvement in terms of both increasing heat resistance and inhibiting air permeability increase with respect to the substrate.

PTL 6 proposes a battery separator having a heat-resistant porous layer on at least one side of a polyolefin microporous membrane, which exhibits excellent heat shrinkage resistance even when the heat-resistant porous layer is thin, while from the viewpoint of reducing shedding of the heat-resistant porous layer, its heat shrinkage factor at 150° C./1 hour is 5% or lower and the shedding amount of the heat-resistant porous layer is 0.6 mg or less. PTL 6 not only mentions polyacrylamide in the heat-resistant porous layer but also specifies the BET specific surface area of the barium sulfate particles, but since the particle size distribution of the barium sulfate particles is unknown it could have insufficient heat resistance or deterioration of ion permeability.

In PTL 7, a separator substrate is coated with a composition for a porous membrane that includes barium sulfate particles having a BET specific surface area of 3.0 m²/g to 6.3 m²/g, a water-soluble polymer such as poly(meth)acrylamide, and water, whereby the residual moisture content of a nonaqueous secondary battery comprising the separator is reduced to improve the high-temperature cycle characteristic, and friction with the coating applicator is lowered. Since the particle sizes of the barium sulfate particles are relatively large given the upper limit for the BET specific surface area in PTL 7, it is difficult to reduce the thickness of the coating layer, and due to the relatively large amount of water-soluble polymer to maintain the strength of the coating layer, the increase in air permeability after coating with respect to the substrate is significant.

PTL 8 discloses a nonaqueous secondary battery separator comprising a porous substrate and a heat-resistant porous layer which includes a binder resin and barium sulfate particles, provided on one or both sides of the porous substrate, wherein the Gurley value (JIS P8117:2009) of the nonaqueous secondary battery separator is 50 to 800 sec/100 mL, the value of the Gurley value of the nonaqueous secondary battery separator minus the Gurley value of the porous substrate is 10 to 300 sec/100 mL, the volume ratio of the barium sulfate particles in the heat-resistant porous layer is 50 to 90 vol %, and the mean primary particle size of the barium sulfate particles in the heat-resistant porous layer is 0.01 μm or greater and less than 0.30 μm.

PTL 9 proposes a porous layer disposed on at least one side of a polyolefin microporous membrane, from the viewpoint of both ensuring ion permeability of the multilayer porous membrane and reducing the heat shrinkage factor, specifying the median diameter (D₅₀) of the ionic inorganic filler and the solid mass ratio of the binder polymer with respect to the ionic inorganic filler.

### CITATION LIST

### Patent Literature

[PTL 1] Japanese Unexamined Patent Publication No. 2011-126275
[PTL 2] Japanese Unexamined Patent Publication No. 2010-218749
[PTL 3] International Patent Publication No. WO2011/108539
[PTL 4] International Patent Publication No. WO2014/021293
[PTL 5] International Patent Publication No. WO2021/029397
[PTL 6] Japanese Unexamined Patent Publication No. 2022-089292
[PTL 7] Japanese Unexamined Patent Publication No. 2015-162313
[PTL 8] Japanese Patent Publication No. 6526359
[PTL 9] Japanese Unexamined Patent Publication No. 2020-116925

### SUMMARY

### Technical Problem

In recent years it has been desired to reduce the thicknesses of nonaqueous electrolyte solution battery separators in order to increase energy densities for nonaqueous electrolyte solution batteries. In order to ensure safety for nonaqueous electrolyte solution batteries, an inorganic porous layer is provided by coating a substrate surface with a layer containing inorganic particles or an inorganic filler. It is essential to reduce the thickness of the inorganic porous layer from the viewpoint of increasing nonaqueous electrolyte solution battery energy density and reducing separator thickness.

With increasingly high strengths of separator substrates in recent years, however, the tendency for such substrates to undergo heat shrinkage means that if the inorganic porous layer thickness is simply reduced, it lowers the heat shrinkage resistance and strength of the inorganic porous layer, making it difficult to inhibit heat shrinkage of the separator as a whole, or in other words, to ensure safety. One possible solution may be to lower the particle size of the inorganic particles or inorganic filler in the inorganic porous layer in order to reduce the thickness of the inorganic porous layer while minimizing heat shrinkage, but this can increase the friction on the separator surface as a whole and impair the pin removal property. Consequently, thickness reduction of the separator as a whole, including reduction in the inorganic porous layer or inorganic coating layer thickness, in a manner corresponding with increased strength of separator substrates, has not yet been achieved.

In light of these circumstances, it is an object of the present invention to provide a multilayer porous membrane that can improve heat resistance (ability to inhibit heat shrinkage) and strength when the thickness of a nonaqueous electrolyte solution battery separator has been decreased, while inhibiting friction on the separator surface as a whole, and that can also increase energy density in a nonaqueous electrolyte solution battery, as well as a nonaqueous electrolyte solution battery separator and a nonaqueous electrolyte solution battery comprising the same.

### Solution to Problem

The present inventors have completed this invention upon finding that the aforementioned object can be achieved by specifying the particle size and percentage of inorganic particles and the frictional coefficient of the porous layer in a multilayer porous membrane having a microporous membrane comprising a polyolefin resin as the main component, and a porous layer comprising inorganic particles, layered on at least one side of the microporous membrane. Examples of embodiments of the invention are the following.
(1) A multilayer porous membrane having
   a microporous membrane comprising a polyolefin resin as a main component; and
   a porous layer comprising inorganic particles, layered on at least one side of the microporous membrane, wherein:
a mean particle size D₅₀ of the inorganic particles is 0.01 μm or greater and smaller than 0.60 μm,
a weight ratio of the inorganic particles in the porous layer is greater than 80%,
a volume ratio of the inorganic particles in the porous layer is greater than 70%,
a surface static friction coefficient of the porous layer is 0.01 to 0.40, and
a surface dynamic friction coefficient of the porous layer is 0.01 to 0.35.
(2) The multilayer porous membrane according to (1) above, wherein an air permeability of the multilayer porous membrane is 400 sec/100 cm³ or lower.
(3) The multilayer porous membrane according to (1) or (2) above, wherein a basis weight-equivalent puncture strength of the microporous membrane is 0.49 N/(g/m²) or greater.
(4) The multilayer porous membrane according to any one of (1) to (3) above, wherein a thickness of the porous layer is 4 μm or smaller on at least one side of the microporous membrane.
(5) The multilayer porous membrane according to any one of (1) to (4) above, wherein an air permeability of the porous layer is 100 sec/100 cm³ or lower.
(6) The multilayer porous membrane according to any one of (1) to (5) above, wherein a ratio (surface static friction coefficient/surface dynamic friction coefficient) of the surface static friction coefficient with respect to the surface dynamic friction coefficient is 1.07 or lower.
(7) The multilayer porous membrane according to any one of (1) to (6) above, wherein a heat shrinkage factor of the multilayer porous membrane at 150° C. is 10% or lower in both the MD direction and TD direction.
(8) The multilayer porous membrane according to any one of (1) to (7) above, wherein the multilayer porous membrane is a separator for a nonaqueous electrolyte solution battery.
(9) A nonaqueous electrolyte solution battery comprising a positive electrode, the multilayer porous membrane according to (8) above, a negative electrode and a nonaqueous electrolyte solution.

### Advantageous Effects of Invention

According to the invention it is possible to provide a multilayer porous membrane that can improve heat resistance (the ability to inhibit heat shrinkage) and strength when the thickness of a nonaqueous electrolyte solution battery separator has been decreased, while inhibiting friction on the separator surface as a whole, and that can also increase energy density in a nonaqueous electrolyte solution battery, as well as a nonaqueous electrolyte solution battery separator and a nonaqueous electrolyte solution battery using the same, which exhibit an improved pin removal property.

### BRIEF DESCRIPTION OF DRAWINGS

FIG. 1 is a schematic cross-sectional diagram for illustration of the wound state of a separator for a power storage device, a positive electrode and a negative electrode forming a wound body around a pin.

FIGS. 2A and 2B are schematic diagrams showing the overall construction of a manual winding device (2A) and a winding unit configuration (2B).

### DESCRIPTION OF EMBODIMENTS

An embodiment for carrying out the invention (hereunder also referred to as “the embodiment”) will now be explained for illustration purposes, with the understanding that the invention is not limited to the embodiment. The upper limits and lower limits for the numerical ranges throughout the present specification may be combined as desired. That a member contains a specific component as a main component means that the content of the specific component is 50 weight % or greater based on the weight of the member. Unless otherwise specified, the physical properties and numerical values described herein are those measured or calculated by the methods described in the Examples.

As used herein, “MD” refers to the machine direction during continuous molding of a polyolefin microporous membrane, and “TD” refers to the direction transversing the MD of the polyolefin microporous membrane at a 900 angle.

Also as used herein, the “pin removal property” is the property of eliminating defects during pin removal when a multilayer porous membrane or nonaqueous electrolyte solution battery separator and an electrode are wrapped around a pin to produce a wound body, and the pin is withdrawn from the wound body. Pin removal defects include shape deformation due to protrusion of the pin-surrounding region of the wound body in the form of a bamboo shoot, collapse of the wound body, step misalignment, and deformation of the edges of the wound body.

### <Multilayer Porous Membrane>

The multilayer porous membrane of the embodiment is a multilayer porous membrane comprising a porous membrane that contains a polyolefin resin as a main component (PO microporous membrane), and a porous layer including inorganic particles, layered on at least one side of the PO microporous membrane.

The multilayer porous membrane of the embodiment can be used as a separator for a nonaqueous electrolyte solution battery (also referred to hereunder simply as “separator”), and by specifying the particle size and percentage of inorganic particles in the porous layer and the frictional coefficient of the porous layer as described below, it is possible to maintain permeability while not only inhibiting friction on the separator surface as a whole when the separator has been reduced in thickness, and increasing the heat resistance (ability to inhibit heat shrinkage) and strength, but also improving the energy density of the nonaqueous electrolyte solution battery.

The structure of the multilayer porous membrane may have a porous layer on one or both sides of the PO microporous membrane, and for example, it may be a two-layer structure comprising a first porous layer that includes inorganic particles and a PO microporous membrane, or a three-layer structure comprising, in order, a first porous layer, a PO microporous membrane and a second porous layer that includes inorganic particles.

The multilayer structure is not limited to a two-layer structure (first porous layer-PO microporous membrane) or a three-layer structure (first porous layer-PO microporous membrane-second porous layer), and if desired, one or more additional layers may be formed between the first porous layer and the PO microporous membrane, between the second porous layer and the PO microporous membrane, or on at least one side or the outsides of the multilayer porous membrane, for example. Examples of additional layers include an additional PO microporous membrane, an additional porous layer including inorganic particles and a binder polymer, a resin layer comprising 50 weight % or greater of a resin other than polyolefin (PO), and a thermoplastic polymer-containing layer which includes a binder component having an adhesion function, such as a thermoplastic polymer.

The constituent elements of the multilayer porous membrane of the embodiment will now be described.

### <Porous Layer>

The porous layer is a layer formed on at least one side of a microporous membrane comprising a polyolefin resin as the main component, and containing inorganic particles. The porous layer may also include a resin binder and a dispersing agent, as desired.

### (Relationship Between Particle Size and Percentage of Inorganic Particles and Frictional Coefficient of Porous Layer)

For the porous layer of the embodiment, the mean particle size D₅₀ of the inorganic particles is 0.01 μm or greater and smaller than 0.60 μm, the weight ratio of inorganic particles in the porous layer is greater than 80%, the volume ratio of inorganic particles in the porous layer is greater than 70%, the surface static friction coefficient (μₛ) of the porous layer is 0.01 to 0.40, and the surface dynamic friction coefficient (μ′ₛ) of the porous layer is 0.01 to 0.35.

For the porous layer of the multilayer porous membrane of the embodiment, if the mean particle size D₅₀ of the inorganic particles, the weight ratio (Wᵢ) and volume ratio (Vᵢ) of the inorganic particles in the porous layer, the surface static friction coefficient (μₛ) and the surface dynamic friction coefficient (μ′ₛ) of the porous layer satisfy the following relationships:

0.01 μm≤D₅₀<0.60 μm

80%<Wᵢ

70%<Vᵢ

0.01≤μₛ≤0.40

0.01≤μ′ₛ≤0.35

then with a separator of reduced thickness it will be possible to achieve high levels for both heat resistance and the rate and cycle performance of the nonaqueous electrolyte solution battery while inhibiting friction on the separator surface as a whole, thus improving the pin removal property and the safety in nail penetration testing of the nonaqueous electrolyte solution battery.

Based on the relationships shown above, it was found that in the porous layer disposed on at least one side of the microporous membrane of the multilayer porous membrane, inorganic particles of relatively small particle sizes are densely packed, while surface friction on the multilayer porous membrane as a whole is reduced, so that it is possible to achieve thickness reduction, high heat resistance, high ion permeability and a high pin removal property for the multilayer porous membrane.

A high degree of success is obtained for low friction, high heat-resistance and low resistance of the multilayer porous membrane within the relationship ranges represented above, when the total thickness of the multilayer porous membrane is significantly small, when the thickness of the porous layer (T) is 4 μm or smaller on at least one side of the PO microporous membrane, when the amount of resin binder in the porous layer is significantly low and when the ratio T/TB of the thickness (TB) of the PO microporous membrane and the thickness T of the porous layer is 0.10 to 0.35.

For the surface static friction coefficient (μₛ) of the porous layer, preferably 0.01≤μₛ≤0.40 is satisfied in the MD and/or TD, and 0.01≤μₛ≤0.40 is satisfied at least in the MD. For the μₛ of the porous layer, preferably the relationship represented by the following inequality:

0.01≤μₛ≤0.35

is satisfied in the MD and/or TD, from the viewpoint of inhibiting friction on the multilayer porous membrane as a whole, and obtaining high heat resistance, a high pin removal property and low resistance.

For the surface dynamic friction coefficient (μ′ₛ) of the porous layer, preferably 0.01 's 0.35 is satisfied in the MD and/or TD, and 0.01≤μ′ₛ≤0.35 is satisfied at least in the MD. For the μ′ₛ of the porous layer, preferably the relationship represented by the following inequality:

0.01≤μ′ₛ≤0.30

is satisfied in the MD and/or TD, from the viewpoint of inhibiting friction on the multilayer porous membrane as a whole, and obtaining high heat resistance, a high pin removal property and low resistance.

In order to achieve high levels for low friction, high heat-resistance and low resistance of the multilayer porous membrane, the ratio of the surface static friction coefficient with respect to the surface dynamic friction coefficient of the porous layer (μₛ/μ′ₛ) is preferably 1.07 or lower and/or 0.09 or higher in the MD and/or TD, and the ratio (μₛ/μ′ₛ) is more preferably 1.00 or higher and/or 1.04 or lower in at least the MD.

The relationship for the surface friction coefficient of the porous layer described above can be obtained by selection of the type of inorganic particle material based on the stress relaxation rate in a shearing test, addition of inorganic particles into the slurry based on a prescribed weight ratio (Wᵢ) and/or volume ratio (Vᵢ), or dispersion, stirring and particle size control of the inorganic particles in the inorganic particle-containing slurry, during the process of disposing the porous layer on the microporous membrane or substrate or the production process for the separator.

A smaller value of the mean particle size D₅₀ of the inorganic particles in the porous layer within the range satisfying 0.01 μm≤D₅₀<0.60 μm, results in more adhesion points between the inorganic particles and resin binder or more bonding points between the porous layer and the PO microporous membrane and contact points between the inorganic particles, increasing the heat resistance, and also results in smaller pore sizes in the porous layer, thus improving the cycle performance due to more uniform current density of the nonaqueous electrolyte solution battery. From the viewpoint of obtaining a high degree of low friction, high heat-resistance and low resistance for the multilayer porous membrane, the mean particle size D₅₀ of the inorganic particles is preferably 0.01 μm or larger, more preferably 0.10 μm or larger, even more preferably 0.20 μm or larger and most preferably 0.25 μm or larger, and the D₅₀ is also preferably 0.50 μm or smaller, more preferably 0.45 μm or smaller, even more preferably 0.40 μm or smaller and most preferably 0.35 μm or smaller.

The mean particle size or particle size distribution of the inorganic particles described above can be obtained by selection of the type of inorganic particle material based on the stress relaxation rate in a shearing test, or dispersion, stirring and particle size control of the inorganic particles in the inorganic particle-containing slurry, during the process of disposing the porous layer on the microporous membrane or substrate or the production process for the separator.

More specifically, the method of adjusting the particle size distribution of the inorganic particles may be, for example, a method of pulverizing the inorganic particles using a ball mill, bead mill or jet mill to obtain the desired particle size distribution, or a method of preparing multiple inorganic particles with different particle size distributions and then blending them.

If the weight ratio (Wᵢ) of the inorganic particles in the porous layer is greater than 80%, the proportions of other components such as the resin binder will be relatively lower, thereby facilitating control of the frictional coefficient or the inorganic particle sizes, as described above, and resulting in increased air permeability of the porous membrane compared to the PO microporous membrane, reduced battery resistance, and an improved cycle characteristic. The Wᵢ value of the inorganic particles in the porous layer is preferably greater than 90%, more preferably greater than 93% or greater, even more preferably 95% or greater and most preferably 97% or greater, from the viewpoint of obtaining a high degree of low friction, high heat-resistance and low resistance for the multilayer porous membrane. The upper limit for Wᵢ is not particularly restricted, and may be 100% or lower, lower than 100% or 99% or lower, for example.

The volume ratio (Vᵢ) of the inorganic particles in the porous layer is greater than 70%, with 100 vol % as the volume of the porous layer minus the voids. If the Vᵢ value of the inorganic particles in the porous layer is greater than 70%, the proportion of inorganic particles with respect to the other components such as the resin binder will be increased, thereby facilitating adjustment of the frictional coefficient or the inorganic particle sizes as described above, and making it possible to inhibit increase in air permeability of the PO microporous membrane due to the porous layer, and to lower the electrical resistance of the multilayer porous membrane. From the viewpoint of obtaining a high degree of low friction, high heat-resistance and low resistance for the multilayer porous membrane, the Vᵢ value of the inorganic particles in the porous layer is preferably greater than 75%, more preferably greater than 80%, even more preferably greater than 85% and most preferably greater than 90%, and also preferably 95% or lower, more preferably 93% or lower, even more preferably 92% or lower and most preferably 91% or lower.

### (Inorganic Particles)

The inorganic particles used for the porous layer are not particularly restricted and may be the inorganic filler for the porous layer, and they preferably have high heat resistance and electrical insulating properties and are also electrochemically stable in the range in which the nonaqueous electrolyte solution battery is to be used.

Examples of materials for the inorganic particles include oxide-based ceramics such as alumina, silica, titania, zirconia, magnesia, ceria, yttria, zinc oxide and iron oxide; nitride-based ceramics such as silicon nitride, titanium nitride and boron nitride; ceramics such as silicon carbide, calcium carbonate, magnesium sulfate, aluminum sulfate, barium sulfate, aluminum hydroxide, aluminum oxide hydroxide or boehmite, potassium titanate, talc, kaolinite, dickite, nacrite, halloysite, pyrophyllite, montmorillonite, sericite, mica, amesite, bentonite, asbestos, zeolite, calcium silicate, magnesium silicate, diatomaceous earth and quartz sand; and glass fibers. One or more selected from the group consisting of alumina, boehmite and barium sulfate are preferred from the viewpoint of stability in the nonaqueous electrolyte solution battery, while barium sulfate is more preferred from the viewpoint of reducing friction on the multilayer porous membrane as a whole, the viewpoint of the stress relaxation rate in a shearing test, and the viewpoint of facilitating control of μₛ and/or μ′ₛ for the porous layer. The barium sulfate is not particularly restricted, but it may be barium sulfate with a specific gravity of about 4.50, for example, and is preferably obtained by the sulfuric acid method from the viewpoint of obtaining a suitable stress relaxation rate regardless of whether surface treatment is used, and also from the viewpoint of helping to control the s and/or μ′ₛ value of the porous layer. Synthetic boehmite is even more preferred as boehmite, because it can reduce ionic impurities that may adversely affect the properties of nonaqueous electrolyte solution batteries. The inorganic particles may be used alone, or more than one type may be used together.

Examples of inorganic particle forms include laminar, scaly, polyhedral, needle-like, columnar, granular, spherical, fusiform and block-shaped forms, and various combinations of inorganic particles with these forms may also be used. Preferred among these are block-shaped forms from the viewpoint of balance between permeability and heat resistance, with largely particulate forms being preferred for barium sulfate. Multiple different barium sulfate forms may also be used in combination.

The aspect ratio of the inorganic particles is preferably 1.0 to 3.0 and more preferably 1.1 to 2.5. The aspect ratio is preferably 3.0 or lower from the viewpoint of inhibiting moisture adsorption on the multilayer porous membrane and preventing capacity deterioration of the nonaqueous electrolyte solution battery with repeated cycling, and also from the viewpoint of inhibiting deformation at temperatures above the melting point of the PO microporous membrane.

The BET specific surface area of the inorganic particles is preferably 5.00 m²/g to 50.0 m²/g, more preferably 6.00 m²/g to 30.00 m²/g, even more preferably 6.00 to 20.00 m²/g, yet more preferably 15.00 m²/g or lower, even yet more preferably 6.00 to 12.00 m²/g, especially preferably 6.00 to 10.00 m²/g, very especially preferably 6.31 to 6.99 m²/g, most especially preferably lower than 6.50 m²/g and most preferably 6.31 to 6.49 m²/g. If the BET specific surface area of the inorganic particles is 5.00 m²/g or greater, the pores of the porous layer will be smaller and the current density of the nonaqueous electrolyte solution battery will be more uniform, thus tending to improve the cycle performance, while the number of contact points between the inorganic particles in the porous layer will also be increased, thus tending to improve the heat resistance. A mean particle size suited for the embodiment can be achieved more easily if the BET specific surface area of the inorganic particles is within the range specified above.

The stress relaxation rate in shear testing of the inorganic particles is preferably 17.0% or lower, more preferably 15.0% or lower and even more preferably 13.0% or lower. If the stress relaxation rate in shear testing of the inorganic particles is 17.0% or lower, the porous layer will be more uniformly formed and the surface friction of the porous layer will be lower. The stress relaxation rate in shear testing of the inorganic particles is also preferably 1.0% or higher, more preferably 5.0% or higher and even more preferably 8.0% or higher. If the stress relaxation rate in shear testing of the inorganic particles is 1.0% or higher, the density of the porous layer will not be too low and a high level of permeability can be obtained.

### (Resin Binder)

The porous layer may also include a resin binder, if desired. The resin binder is a material that binds together numerous inorganic particles in the porous layer and also binds together the porous layer and the PO microporous membrane. As the type of resin binder it is preferred to use one that is insoluble in the electrolyte solution of the nonaqueous electrolyte solution battery and electrochemically stable in the operating range of the nonaqueous electrolyte solution battery, when the multilayer porous membrane is used as a separator.

Specific examples of resin binders include the following 1) to 7).
1) Polyolefins: Polyethylene, polypropylene, ethylene-propylene rubber and modified forms of these;
2) Conjugated diene-based polymers: For example, styrene-butadiene copolymers and their hydrides, acrylonitrile-butadiene copolymers and their hydrides and acrylonitrile-butadiene-styrene copolymers and their hydrides;
3) Acrylic-based polymers: For example, methacrylic acid ester-acrylic acid ester copolymers, styrene-acrylic acid ester copolymers, acrylonitrile-acrylic acid ester copolymers and poly(meth)acrylamides;
4) Polyvinyl alcohol-based resins: For example, polyvinyl alcohol and polyvinyl acetate;
5) Fluorine-containing resins: For example, polyvinylidene fluoride, polytetrafluoroethylene, vinylidene fluoride-hexafluoropropylene-tetrafluoroethylene copolymer and ethylene-tetrafluoroethylene copolymer;
6) Cellulose derivatives: For example, ethyl cellulose, methyl cellulose, hydroxyethyl cellulose and carboxymethyl cellulose; and
7) Polymers that are resins with a melting point and/or glass transition temperature of 180° C. or higher, or without a melting point but having a decomposition temperature of 200° C. or higher: For example, polyphenylene ethers, polysulfones, polyethersulfones, polyphenylene sulfides, polyetherimides, polyamideimides, polyamides, polyesters and poly(meth)acrylamides.

Preferred from the viewpoint of further improving the safety during short circuiting are 3) acrylic-based polymers, 5) fluorine-containing resins and 7) polyamide polymers. Polyamides are preferably aramid resins such as total aromatic polyamides, and especially polymetaphenylene isophthalamide, from the viewpoint of durability.

From the viewpoint of compatibility between the resin binder and the electrodes, the 2) conjugated diene-based polymers are preferred, while from the viewpoint of voltage endurance, the 3) acrylic-based polymers and 5) fluorine-containing resins are preferred.

A conjugated diene-based polymer (2) is a polymer that includes a conjugated diene compound as a monomer unit.

Examples of conjugated diene compounds include 1,3-butadiene, 2-methyl-1,3-butadiene, 2,3-dimethyl-1,3-butadiene, 2-chlor-1,3-butadiene, substituted straight-chain conjugated pentadienes and substituted or side chain-conjugated hexadienes, any of which may be used alone or in combinations of two or more. A particularly preferred compound is 1,3-butadiene.

The acrylic-based polymer of 3) is preferably a polymer including a (meth)acrylic-based compound or (meth)acrylamide as the monomer unit, and from the viewpoint of separator resistance it is more preferably a polyvinylidene fluoride (PVDF) or an aramid resin. A (meth)acrylic-based compound is at least one compound selected from the group consisting of (meth)acrylic acid and (meth)acrylic acid esters.

A (meth)acrylic acid used as the 3) acrylic-based polymer may be acrylic acid or methacrylic acid, for example.

Examples of (meth)acrylic acid esters to be used as the 3) acrylic-based polymer include (meth)acrylic acid alkyl esters such as methyl acrylate, methyl methacrylate, ethyl acrylate, ethyl methacrylate, butyl acrylate, butyl methacrylate, 2-ethylhexyl acrylate and 2-ethylhexyl methacrylate; and epoxy group-containing (meth)acrylic acid esters such as glycidyl acrylate and glycidyl methacrylate; any of which may be used alone or in combinations of two or more. Particularly preferred among these are 2-ethylhexyl acrylate (EHA) and butyl acrylate (BA).

An acrylic-based polymer is preferably a polymer including (meth)acrylamide, EHA or BA as a main structural unit, from the viewpoint of safety in nail penetration testing. A “main structural unit” is a portion of the polymer corresponding to a monomer constituting at least 40 mol % of the entire starting material used to form the polymer.

The conjugated diene-based polymer (2) and acrylic-based polymer (3) may also be obtained by copolymerization with other monomers that are copolymerizable with them. Examples of other copolymerizable monomers to be used include unsaturated carboxylic acid alkyl esters, aromatic vinyl-based monomers, vinyl cyanide-based monomers, unsaturated monomers with hydroxyalkyl groups, unsaturated amide carboxylate monomers, crotonic acid, maleic acid, maleic acid anhydride, fumaric acid and itaconic acid, any of which may be used alone or in combinations of two or more. Unsaturated carboxylic acid alkyl ester monomers are particularly preferred among these. Unsaturated carboxylic acid alkyl ester monomers include dimethyl fumarate, diethyl fumarate, dimethyl maleate, diethyl maleate, dimethyl itaconate, monomethyl fumarate and monoethyl fumarate, any of which may be used alone or in combinations of two or more.

The conjugated diene-based polymer (2) can be obtained by copolymerization of the aforementioned (meth)acrylic-based compound as another monomer.

The resin binder in the porous layer of the embodiment is preferably either or both a water-soluble polymer and a water-insoluble polymer, more preferably with a poly(meth)acrylamide backbone in both the water-soluble polymer and water-insoluble polymer, and even more preferably as an acrylic-based polymer latex form or including a poly(meth)acrylamide. An acrylic-based polymer latex is preferred from the viewpoint of exhibiting high binding force between inorganic particles even at high temperatures above ordinary temperature, and inhibiting heat shrinkage. Poly(meth)acrylamide is generally classified as a water-soluble polymer. If the porous layer contains a water-soluble polymer such as poly(meth)acrylamide, suitable for the reduction in particle sizes of the inorganic particles, it will be possible to adapt to inorganic particles having the weight ratio or volume ratio described above.

The poly(meth)acrylamide may be amphoteric, cationic, anionic or nonionic, with an anionic form being preferred.

The resin binder may be a homopolymer or copolymer, and therefore the resin binder may include poly(meth)acrylamide, the resin binder may consist entirely of poly(meth)acrylamide, the resin binder may be a mixture of poly(meth)acrylamide with another polymer or a copolymer of (meth)acrylamide with another monomer, or part of the polymer backbone of the resin binder may include a repeating unit of a constituent element derived from (meth)acrylamide.

From the viewpoint of binding force between different inorganic particles and the ability to inhibit heat shrinkage, the lower limit for the weight-average molecular weight of the water-soluble polymer is preferably 1,000 or greater, more preferably 10,000 or greater, even more preferably 100,000 or greater and especially preferably 150,000 or greater, while the upper limit is preferably 3,000,000 or lower, more preferably 2,000,000 or lower, even more preferably 1,000,000 or lower and especially preferably 700,000 or lower.

From the viewpoint of the binding force between different inorganic particles and the ability to inhibit heat shrinkage, the weight ratio Wa of the water-soluble polymer in the porous layer is preferably greater than 0 weight %, with an upper limit of preferably 5.0 weight % or lower, more preferably 2.0 weight % or lower and even more preferably 3.0 weight % or lower.

The resin binder used for the embodiment preferably includes a water-insoluble binder from the viewpoint of its heat shrinkage inhibiting ability and permeability. The water-insoluble binder can be composed of one or more types of water-insoluble binders among 1) to 7) mentioned above, being preferably in the form of a latex of water-insoluble binder particles, and more preferably a latex of water-insoluble acrylic-based polymer particles.

The mean particle size D₅₀ of water-insoluble binder particles in a latex is preferably 0.50 μm or smaller from the viewpoint of inhibiting heat shrinkage with smaller particle sizes, and also preferably 0.01 μm or larger from the viewpoint of improving the permeability with larger particle sizes. From the viewpoint of both heat shrinkage inhibiting ability and permeability, it is more preferred to use two types of water-insoluble binders with different particle size distributions in the latex.

When two different water-insoluble binders are used, the first water-insoluble binder of relatively small particle size preferably has a mean particle size D₅₀ of 0.01 μm or larger and/or preferably has a mean particle size D₅₀ of 0.50 μm or smaller, from the viewpoint of inhibiting heat shrinkage.

The second water-insoluble binder of relatively large particle size, on the other hand, preferably has a mean particle size D₅₀ equal to or greater than the mean particle size D₅₀ of the inorganic particles, from the viewpoint of permeability and also from the viewpoint of causing it to protrude beyond the average thickness of the porous layer to form voids between the separator and electrodes, so that the voids alleviate the effects of expansion and contraction of the electrodes during charge-discharge of the nonaqueous electrolyte solution battery, and improve the cycle characteristic. From the same viewpoint, the mean particle size D₅₀ of the second water-insoluble binder is preferably 0.3 μm or greater, more preferably 0.5 μm or greater and even more preferably 0.50 μm or greater, with an upper limit of preferably 5.0 μm or smaller, more preferably 4.0 μm or smaller and even more preferably 3.0 μm or smaller.

From the viewpoint of heat shrinkage inhibiting ability and permeability, the weight ratio Wb of the water-insoluble binder in the porous layer is preferably 0 weight % or greater, with an upper limit of preferably 5.0 weight % or lower, more preferably 2.0 weight % or lower and even more preferably 3.0 weight % or lower.

The weight ratio of the water-soluble polymer in the porous layer is preferably higher than the weight ratio of the water-insoluble binder (that is, the ratio of the weight ratio Wb of the water-insoluble binder with respect to the weight ratio Wa of the water-soluble polymer in the porous layer (Wb/Wa ratio) is preferably less than 1.0) but it is more preferably less than 0.5 and even more preferably less than 0.3, although the Wb/Wa ratio is preferably 0.0 or greater. If a water-soluble polymer is included in the porous layer and the weight ratio of the water-soluble polymer is greater than the weight ratio of the water-insoluble binder, then the resin binder will cover the inorganic particles as a coating in proportion to the excess, further increasing the number of contact points between them and further improving the heat resistance of the multilayer porous membrane or separator.

### (Dispersing Agent)

If desired, the porous layer may also include a dispersing agent in addition to the inorganic particles and resin binder. Examples of dispersing agents include a polycarboxylic acid salt such as a polyacrylic acid salt, or a sulfonic acid salt or polyoxy ether. The content of the dispersing agent is preferably 0.0 weight % or greater, more preferably greater than 0.0 weight % and even more preferably 0.3 weight % to 0.7 weight % based on the solid content of the porous layer, and the content of the dispersing agent is also preferably 5.0 weight % or lower, more preferably 1.0 weight % or lower and even more preferably 0.7 weight % or lower based on the solid content of the porous layer.

### (Physical Properties of Porous Layer)

The proportion of the resin binder is preferably lower than 30 vol %, more preferably 20 vol % or lower, even more preferably lower than 10 vol % and especially preferably lower than 9 vol %, where the volume of the porous layer minus the voids is 100 vol %, with a lower limit of preferably 0.1 vol % or higher. If the volume ratio of the resin binder in the porous layer is within this range, the proportion of inorganic particles with respect to the resin binder will increase, thereby facilitating adjustment of the surface friction coefficient of the porous layer and the particle size and percentage of inorganic particles as explained above, and inhibiting increase in air permeability of the microporous membrane due to the porous layer, so that the electrical resistance of the multilayer porous membrane can be lowered.

The thickness (T) of the porous layer is preferably 4 μm or smaller, more preferably smaller than 3 μm, even more preferably smaller than 2.5 μm, yet more preferably 2.4 μm or smaller, especially preferably 2.0 μm or smaller and most preferably 1.5 μm or smaller, on at least one side of the PO microporous membrane, with the lower limit being preferably 0.1 μm or greater, more preferably 0.5 μm or greater, even more preferably 0.7 μm or greater and especially preferably 1.0 μm or greater. If the thickness (T) of the porous layer having the surface friction coefficient and particle size and percentage of inorganic particles explained above is 4 μm or smaller, then the electrical resistance of the multilayer porous membrane or separator will be lower, potentially increasing the capacity and cycle characteristic of the nonaqueous electrolyte solution battery.

The thickness of the porous layer T may include the porous layer when formed only on at least one side of the PO microporous membrane, or when formed on both sides of the PO microporous membrane. When the porous layer is formed on both sides of the PO microporous membrane, the total thickness of the porous layer is preferably within the range specified above.

The air permeability of the porous layer is preferably 100 sec/100 cm³ or lower, more preferably 50 sec/100 cm³ or lower, even more preferably 40 sec/100 cm³ or lower, yet more preferably 30 sec/100 cm³ or lower, even yet more preferably 25 sec/100 cm³ or lower and most preferably 20 sec/100 cm³ or lower, with a lower limit of preferably 1 sec/100 cm³ or higher, more preferably 3 sec/100 cm³ or higher, even more preferably 5 sec/100 cm³ or higher and most preferably 10 sec/100 cm³ or higher. If the air permeability of the porous layer is 100 sec/100 cm³ or lower the electrical resistance will be lower, tending to increase the capacity and cycle characteristic of the nonaqueous electrolyte solution battery. From the same viewpoint, the air permeability per thickness of the porous layer is preferably 30 (see/100 cm³)/μm or lower, more preferably 25 (see/100 cm³)/μm or lower, even more preferably 20 (see/100 cm³)/μm or lower and most preferably 15 (see/100 cm³)/μm or lower, with a lower limit of preferably 1 (see/100 cm³)/μm or higher and more preferably 3 (see/100 cm³)/μm or higher.

The layer density in the porous layer has a lower limit of preferably 1.0 g/(m² μm) or higher, more preferably 1.5 g/(m²·μm) or higher and even more preferably 2.0 g/(m²·μm) or higher, with an upper limit of preferably 5.0 g/(m²·μm) or lower, more preferably 4.0 g/(m²·μm) or lower and even more preferably 3.0 g/(m²·μm) or lower. The layer density in the porous layer is preferably 1.0 g/(m²·μm) or higher from the viewpoint of inhibiting deformation at temperatures above the melting point of the PO microporous membrane, and preferably 5.0 g/(m²·μm) or lower from the viewpoint of preventing capacity deterioration with repeated cycling, while maintaining the ion permeability of the porous layer.

The 180° peel strength of the porous layer from the multilayer porous membrane or PO microporous membrane is preferably 100 N/m or greater, more preferably 200 N/m or greater, even more preferably 250 N/m or greater, yet more preferably 300 N/m or greater and most preferably 400 N/m or greater, as the lower limit, and preferably 800 N/m or lower, more preferably 750 N/m or lower, even more preferably 700 N/m or lower, yet more preferably 600 N/m or lower and most preferably 500 N/m or lower, as the upper limit. The “1800 peel strength” is the strength when the covering layer has been peeled in a manner so that the surface facing the substrate of the covering layer forms a 180° angle with respect to the substrate. A 1800 peel strength of 100 N/m or greater increases the adhesive force with electrodes and inhibits heat shrinkage.

### <Polyolefin Microporous Membrane>

The porous membrane comprising a polyolefin as the main component (PO microporous membrane) includes a polyolefin, and is preferably composed entirely of the polyolefin. The form of the polyolefin may be a microporous polyolefin, such as a polyolefin membrane, polyolefin fiber fabric (woven fabric) or polyolefin fiber nonwoven fabric. Examples of polyolefins include homopolymers, copolymers or multistage polymers obtained using monomers such as ethylene, propylene, 1-butene, 4-methyl-1-pentene, 1-hexene and 1-octene, any of which polymers may be used alone or in blends of two or more. From the viewpoint of melt viscosity, shutdown property and meltdown property of the PO microporous membrane to be used in the separator, the polyolefin is preferably one or more selected from the group consisting of polyethylene, polypropylene and their copolymers, more preferably it includes polypropylene, and even more preferably it is ethylene-propylene copolymer or a blend of polyethylene and polypropylene.

Specific examples of polyethylene include low-density polyethylene (LDPE), linear low-density polyethylene (LLDPE), medium-density polyethylene (MDPE), high-density polyethylene (HDPE), high molecular weight polyethylene (HMWPE) and ultrahigh molecular weight polyethylene (UHMWPE).

Throughout the present specification, high molecular weight polyethylene (HMWPE) is polyethylene having a viscosity-average molecular weight (Mv) of 100,000 or greater. Since the My of ultrahigh molecular weight polyethylene (UHMWPE) is generally 1,000,000 or greater, the definition of high molecular weight polyethylene (HMWPE) for the purpose of the present specification includes UHMWPE.

Throughout the present specification, the term “high-density polyethylene” refers to polyethylene having a density of 0.942 to 0.970 g/cm³. The density of polyethylene, for the purpose of the invention, is the value measured according to: D) Density gradient tube method, of JIS K7112(1999).

Specific examples of polypropylene include isotactic polypropylene, syndiotactic polypropylene and atactic polypropylene.

Specific examples of copolymers of ethylene and propylene include ethylene-propylene random copolymers and ethylene-propylene rubber.

When the polyolefin (PO) in the PO microporous membrane includes polyethylene (PE), the PE content is 50 weight % to 100 weight % based on the total weight of the resin component composing the PO microporous membrane, and it is preferably 70 weight % or greater, more preferably 80 weight % or greater, even more preferably 90 weight % or greater and most preferably 93 weight % or greater, from the viewpoint of the fuse characteristic or meltdown property.

When the PO in the PO microporous membrane includes polypropylene (PP), the PP content is greater than 0 weight % and less than 50 weight % based on the total weight of the resin component composing the PO microporous membrane, and from the viewpoint of the melt viscosity and fuse characteristic it is preferably 30 weight % or lower, more preferably 20 weight % or lower, even more preferably 10 weight % or lower and most preferably 7 weight % or lower.

In addition to the polyolefin mentioned above, the PO microporous membrane may further include a resin such as polyethylene terephthalate, polycycloolefin, polyethersulfone, polyamide, polyimide, polyimideamide, polyaramid, polyvinylidene fluoride, nylon or polytetrafluoroethylene.

From the viewpoint of inhibiting high-viscosity of the PO resin composition during film formation to reduce generation of defects, the melt index (MI) of the PO microporous membrane at 190° C. is preferably 0.01 g/10 min or higher, more preferably 0.02 g/10 min or higher, even more preferably 0.03 g/10 min or higher, especially preferably 0.04 g/10 min or higher and most preferably 0.05 g/10 min or higher, as the lower limit, and preferably 0.70 g/10 min or lower, more preferably 0.60 g/10 min or lower, even more preferably 0.40 g/10 min or lower, especially preferably 0.30 g/10 min or lower and most preferably 0.20 g/10 min or lower, as the upper limit.

The puncture strength in terms of the basis weight (g/m²) of the PO microporous membrane (hereunder referred to as “basis weight-equivalent puncture strength”) is preferably 50 gf/(g/m²) or greater (0.49 N/(g/m²) or greater). A PO microporous membrane having a basis weight-equivalent puncture strength of 0.49 N/(g/m²) or greater will tend to be resistant to tearing. The basis weight-equivalent puncture strength of the PO microporous membrane is more preferably 0.54 N/(g/m²) or greater, even more preferably 0.59 N/(g/m²) or greater and most preferably 0.69 N/(g/m²) or greater, from the viewpoint of resistance to tearing. From the viewpoint of improving safety of the nonaqueous electrolyte solution battery while maintaining strength for the PO microporous membrane, the basis weight-equivalent puncture strength is preferably 1.96 N/(g/m²) or lower, more preferably 1.47 N/(g/m²) or lower, even more preferably 1.18 N/(g/m²) or lower, yet more preferably 1.08 N/(g/m²) or lower and most preferably 0.98 N/(g/m²).

The puncture strength that is not in terms of the basis weight of the PO microporous membrane (hereunder referred to simply as “puncture strength”) is preferably 0.98 N or greater, more preferably 1.47 N or greater and even more preferably 1.96 N or greater, from the viewpoint of inhibiting tearing, and preferably 9.80 N or lower, more preferably 5.88 N or lower and even more preferably 4.90 N or lower, from the viewpoint of improving the safety of the nonaqueous electrolyte solution battery while maintaining membrane strength.

The puncture strength or basis weight-equivalent puncture strength can be increased by increasing the orientation of the molecular chains by application of shearing force or stretching of the molded article during extrusion, but since increasing the strength also impairs the thermostability due to higher residual stress, this is controlled as suitable for the purpose.

From the viewpoint of ensuring voltage endurance, the thickness (TB) of the PO microporous membrane is preferably 1.0 μm or larger, more preferably 2.0 μm or larger even more preferably 3.0 μm or larger, yet more preferably 4.0 μm or larger and most preferably 4.5 μm or larger, while from the viewpoint of ensuring nonaqueous electrolyte solution battery capacity it is preferably 30.0 μm or smaller, more preferably 20.0 μm or smaller, even more preferably 16.0 μm or smaller, yet more preferably 12.0 μm or smaller and most preferably 9.0 μm or smaller. The thickness TB of the PO microporous membrane can be adjusted by controlling the die lip gap or the stretch ratio during the stretching step, for example.

From the viewpoint of permeability, the porosity of the PO microporous membrane is preferably 20% or higher, more preferably 30% or higher, even more preferably 35% or higher and most preferably 40% or higher, while from the viewpoint of membrane strength it is preferably 80% or lower, more preferably 70% or lower, even more preferably 60% or lower and most preferably 50% or lower. The porosity of the PO microporous membrane can be adjusted, for example, by controlling the blending ratio of the polyolefin resin composition and the plasticizer, the stretching temperature, the stretch ratio, the heat setting temperature, the stretch ratio during heat setting and the relaxation factor during heat setting, or by controlling any combination of these.

The air permeability of the PO microporous membrane is preferably 10 sec/100 cm³ or greater, more preferably 30 sec/100 cm³ or greater, even more preferably 50 sec/100 cm³ or greater and most preferably 70 sec/100 cm³ or greater, from the viewpoint of avoiding excessive flow of current through the PO microporous membranes between multiple electrodes, while it is also preferably 300 sec/100 cm³ or lower, more preferably 250 sec/100 cm³ or lower, even more preferably 200 sec/100 cm³ or lower and most preferably 150 sec/100 cm³ from the viewpoint of permeability.

The viscosity-average molecular weight (Mv) of the PO microporous membrane is preferably 400,000 or greater, more preferably 450,000 or greater and even more preferably 500,000 or greater, as the lower limit, and also preferably 1,300,000 or lower, more preferably 1,200,000 or lower and even more preferably 1,150,000 or lower, as the upper limit. If the My of the PO microporous membrane is 400,000 or greater, the melt tension during melt molding will be increased, resulting in satisfactory moldability, while higher membrane strength will also tend to be obtained due to entanglement between the polymers. If the My is 1,300,000 or lower, uniform melt kneading of the starting materials will be facilitated and the sheet forming properties, and especially the thickness stability, will tend to be superior, while the holes will tend to be obstructed during temperature increase when used as a nonaqueous electrolyte solution battery separator, resulting in a satisfactory fuse function.

The mean pore size of the PO microporous membrane is preferably 0.03 μm or greater, more preferably 0.04 μm or greater, even more preferably 0.05 μm or greater and yet more preferably 0.055 μm or greater, as the lower limit, and preferably 0.70 μm or smaller, more preferably 0.20 μm or smaller, even more preferably 0.10 μm or smaller and yet more preferably 0.09 μm or smaller, as the upper limit. The mean pore size of the PO microporous membrane is preferably 0.03 μm to 0.70 μm from the viewpoint of ionic conductivity and voltage endurance. The mean pore size can be adjusted, for example, by controlling the compositional ratio of the polyolefins, the types of polyolefins or plasticizers, the cooling rate of the extruded sheet, the stretching temperature, the stretch ratio, the heat setting temperature, the stretch ratio during heat setting and the relaxation factor during heat setting, or by controlling any combination of these.

The PO microporous membrane preferably has low electron conductivity, exhibits ionic conductivity, has high resistance to organic solvents and has fine pore sizes. The PO microporous membrane can be utilized alone as a separator for a lithium ion secondary battery, and in particular it can be suitably used as a separator for a laminated lithium ion secondary battery.

### <Thermoplastic Polymer-Containing Layer>

At least one side or the outer sides of the multilayer porous membrane according to one embodiment may be provided with a thermoplastic polymer-containing layer if desired. The thermoplastic polymer-containing layer comprises a thermoplastic polymer. The thermoplastic polymer layer may include polymer particles if desired, and/or may also have a dot pattern.

### (Thermoplastic Polymer)

The thermoplastic polymer is not particularly restricted, and examples include polyolefin resins such as polyethylene, polypropylene and α-polyolefin; fluorine-containing resins such as polyvinylidene fluoride and polytetrafluoroethylene and copolymers comprising them; diene-based polymers having conjugated dienes such as butadiene or isoprene as monomer units, or copolymers and hydrides comprising them; acrylic polymers having acrylic acid esters or methacrylic acid esters as monomer units, or their copolymers or hydrides; rubber compounds such as ethylene-propylene rubber, polyvinyl alcohol and vinyl polyacetate; cellulose derivatives such as ethyl cellulose, methyl cellulose, hydroxyethyl cellulose and carboxymethyl cellulose; and resins having a melting point and/or glass transition temperature of 180° C. or higher, such as polyphenylene ether, polysulfone, polyethersulfone, polyphenylene sulfide, polyetherimide, polyamideimide, polyamide and polyester compounds, and their blends. Monomers to be used for synthesis of thermoplastic polymers include monomers with hydroxyl, sulfonic acid, carboxyl, amide or cyano groups.

Preferred among these thermoplastic polymers are diene-based polymers, acrylic polymers and fluorine-based polymers, for their superior bondability with electrode active materials and superior strength or flexibility.

### (Diene-Based Polymers)

Diene-based polymers are not particularly restricted and examples include polymers that include monomer units obtained by polymerization of conjugated dienes having two conjugated double bonds, such as butadiene or isoprene. Conjugated diene monomers are not particularly restricted, and examples include 1,3-butadiene, isoprene, 2,3-dimethyl-1,3-butadiene, 2-phenyl-1,3-butadiene, 1,3-pentadiene, 2-methyl-1,3-pentadiene, 1,3-hexadiene, 4,5-diethyl-1,3-octadiene and 3-butyl-1,3-octadiene. Any of these may be polymerized alone or, they may be copolymerized.

The proportion of a monomer unit obtained by polymerization of a conjugated diene in the diene-based polymer is not particularly restricted, but it may be 40 weight % or greater, preferably 50 weight % or greater and more preferably 60 weight % or greater of the total diene-based polymer.

The diene-based polymer is not particularly restricted, and examples include homopolymers of conjugated dienes such as polybutadiene and polyisoprene, and copolymers with monomers that are copolymerizable with conjugated dienes. Such a copolymerizable monomer is not particularly restricted, and may be any of the (meth)acrylate monomers or other monomers mentioned below.

Such “other monomers” are not particularly restricted, and examples include α,β-unsaturated nitrile compounds such as acrylonitrile and methacrylonitrile; unsaturated carboxylic acids such as acrylic acid, methacrylic acid, itaconic acid and fumaric acid; styrene-based monomers such as styrene, chlorostyrene, vinyltoluene, t-butylstyrene, vinylbenzoic acid, methyl vinylbenzoate, vinylnaphthalene, chloromethylstyrene, hydroxymethylstyrene, α-methylstyrene and divinylbenzene; olefins such as ethylene and propylene; halogen atom-containing monomers such as vinyl chloride and vinylidene chloride; vinyl esters such as vinyl acetate, vinyl propionate, vinyl butyrate and vinyl benzoate; vinyl ethers such as methyl vinyl ether, ethyl vinyl ether and butyl vinyl ether; vinyl ketones such as methyl vinyl ketone, ethyl vinyl ketone, butyl vinyl ketone, hexyl vinyl ketone and isopropenyl vinyl ketone; heterocyclic ring-containing vinyl compounds such as N-vinylpyrrolidone, vinylpyridine and vinylimidazole; acrylic acid ester and/or methacrylic acid ester compounds such as methyl acrylate and methyl methacrylate; hydroxyalkyl group-containing compounds such as β-hydroxyethyl acrylate and β-hydroxyethyl methacrylate; and amide-based monomers such as acrylamide, N-methylolacrylamide and acrylamide-2-methylpropanesulfonic acid, any of which may be used alone or in combinations of two or more.

### (Acrylic Polymers)

Acrylic polymers are not particularly restricted but are preferably polymers including a monomer unit obtained by polymerization of a (meth)acrylate monomer. When the thermoplastic polymer-containing layer includes an acrylic polymer as a thermoplastic polymer, it preferably includes a copolymer with a (meth)acrylic acid ester monomer unit. It is preferred for the thermoplastic polymer of the thermoplastic polymer-containing layer to include a copolymer with a (meth)acrylic acid ester monomer unit because adhesive force will be improved when the multilayer porous membrane or separator has a low basis weight.

As used herein, “(meth)acrylic acid” refers to “acrylic acid or methacrylic acid”, and “(meth)acrylate” refers to “acrylate or methacrylate”.

(Meth)acrylate monomers are not particularly restricted, and examples include alkyl (meth)acrylates such as methyl (meth)acrylate, ethyl (meth)acrylate, n-propyl (meth)acrylate, isopropyl (meth)acrylate, n-butyl (meth)acrylate, t-butyl (meth)acrylate, pentyl (meth)acrylate, hexyl (meth)acrylate, heptyl (meth)acrylate, octyl (meth)acrylate, 2-ethylhexyl (meth)acrylate, nonyl (meth)acrylate, decyl (meth)acrylate, lauryl (meth)acrylate, n-tetradecyl (meth)acrylate and stearyl (meth)acrylate; hydroxyl group-containing (meth)acrylates such as hydroxyethyl (meth)acrylate, hydroxypropyl (meth)acrylate and hydroxybutyl (meth)acrylate; amino group-containing (meth)acrylates such as aminoethyl (meth)acrylate; and epoxy group-containing (meth)acrylates such as glycidyl (meth)acrylate (GMA).

The proportion of a monomer unit obtained by polymerization of a (meth)acrylate monomer is not particularly restricted, but it may be, for example, 40 weight % or greater, preferably 50 weight % or greater and more preferably 60 weight % or greater of the total acrylic polymer. Acrylic polymers include homopolymers of (meth)acrylate monomers, and copolymers with monomers that are copolymerizable with them.

Such copolymerizable monomers include the “other monomers” mentioned above for diene-based polymers, any of which may be used alone or in combinations of two or more.

### (Fluorine-Based Polymer)

Fluorine-based polymers are not particularly restricted, and examples include vinylidene fluoride homopolymers, and copolymers of monomers that are copolymerizable with them. Fluorine-based polymers are preferred from the viewpoint of electrochemical stability.

The proportion of a monomer unit obtained by polymerization of vinylidene fluoride is not particularly restricted, and it may be, for example, 40 weight % or greater, preferably 50 weight % or greater and more preferably 60 weight % or greater.

Monomers that are copolymerizable with vinylidene fluoride are not particularly restricted, and examples include fluorine-containing ethylenically unsaturated compounds such as vinyl fluoride, tetrafluoroethylene, trifluorochloroethylene, hexafluoropropylene, hexafluoroisobutylene, perfluoroacrylic acid, perfluoromethacrylic acid, and fluoroalkyl esters of acrylic acid or methacrylic acid; non-fluorinated ethylenically unsaturated compounds such as cyclohexyl vinyl ether and hydroxyethyl vinyl ether; and non-fluorinated diene compounds such as butadiene, isoprene and chloroprene.

Of these fluorine-based polymers, homopolymers of vinylidene fluoride, vinylidene fluoride/tetrafluoroethylene copolymer and vinylidene fluoride/tetrafluoroethylene/hexafluoropropylene copolymer are preferred. Vinylidene fluoride/tetrafluoroethylene/hexafluoropropylene copolymer is an especially preferred fluorine-based polymer, the monomer composition usually being 30 to 90 weight % vinylidene fluoride, 50 to 9 weight % tetrafluoroethylene and 20 to 1 weight % hexafluoropropylene. Particles of such fluorine resins may be used alone or in combinations of two or more different types.

Monomers to be used for synthesis of thermoplastic polymers include monomers with hydroxyl, carboxyl, amino, sulfonic acid, amide or cyano groups.

Monomers with hydroxyl groups are not particularly restricted, and may be vinyl-based monomers, such as pentenol.

Monomers with carboxyl groups are also not particularly restricted, and examples include vinyl-based monomers such as unsaturated carboxylic acids or pentenoic acids having ethylenic double bonds, such as (meth)acrylic acid or itaconic acid.

Monomers with amino groups are not particularly restricted and include 2-aminoethyl methacrylate, for example.

Monomers with sulfonic acid groups are not particularly restricted, and examples include vinylsulfonic acid, methylvinylsulfonic acid, (meth)allylsulfonic acid, styrenesulfonic acid, ethyl (meth)acrylate-2-sulfonate, 2-acrylamide-2-methylpropanesulfonic acid and 3-allyloxy-2-hydroxypropanesulfonic acid.

Monomers with amide groups are not particularly restricted, and examples include acrylamide (AM), methacrylamide, N-methylolacrylamide and N-methylolmethacrylamide.

Monomers with cyano groups are not particularly restricted, and examples include acrylonitrile (AN), methacrylonitrile, α-chloroacrylonitrile and α-cyanoethyl acrylate.

The thermoplastic polymer may be one polymer alone or a blend of two or more polymers, but it preferably includes two or more different polymers. The thermoplastic polymer may also be used together with a solvent, the solvent being one that can uniformly and stably disperse the thermoplastic polymer, such as N-methylpyrrolidone, N,N-dimethylformamide, N,N-dimethyl acetamide, water, ethanol, toluene, hot xylene, methylene chloride or hexane, with aqueous solvents being preferred among these. The thermoplastic polymer may also be used in the form of a latex.

### (Glass Transition Temperature of Thermoplastic Polymer)

From the viewpoint of bondability with the substrate and preventing blocking, as well as exhibiting adhesive force between the separator and electrodes, while also ensuring proper distance between the electrodes and separator in the nonaqueous electrolyte solution battery and shortening the electrolyte solution injection time, the thermoplastic polymer composing the thermoplastic polymer-containing layer preferably has thermal properties with at least two glass transition temperatures, at least one of the glass transition temperatures being in the range of 20° C. or lower, and at least one of the glass transition temperatures being in the range of 30° C. to 120° C.

The glass transition temperature is determined from a DSC curve obtained by differential scanning calorimetry (DSC). The glass transition temperature may also be referred to herein as “Tg”.

Specifically, it is determined by the intersection between a straight line extending the low-temperature end baseline in the DSC curve toward the high-temperature end, and the tangent line at the inflection point in the stepwise change region of glass transition. More specifically, it may be determined with reference to the method described in the Examples.

The term “glass transition” refers to when a change in heat quantity accompanying the change in state of a polymer test piece in DSC occurs at the endothermic end. Such a change in heat quantity is observed as a stepwise change in the DSC curve, or a combination of a stepwise change and a peak.

A “stepwise change” is a portion of the DSC curve that moves away from the previous baseline and toward a new baseline. This also includes any combination of a peak and stepwise change.

The “inflection point” is the point at which the slope of the DSC curve is maximum in the stepwise change region. In the stepwise change region, this represents the point where the upwardly convex curve changes to a downwardly convex curve.

The term “peak” refers to a portion of the DSC curve that moves away from the baseline and then returns to the same baseline.

The term “baseline” refers to the DSC curve in the temperature zone where no transition or reaction takes place in the test piece.

If at least one glass transition temperature of the thermoplastic polymer used for this embodiment is in the range of 20° C. or lower, the adhesiveness for the microporous membrane will be superior and blocking will be reduced, resulting in an effect of excellent adhesiveness between the separator and electrodes. The glass transition temperature is preferably −100° C. or higher, more preferably −50° C. or higher, even more preferably −40° C. or higher and especially preferably −6° C. or higher, from the viewpoint of the handling property and blocking resistance, and is also preferably 20° C. or lower, more preferably 10° C. or lower and especially preferably 0° C. or lower, from the viewpoint of adhesiveness with the microporous membrane.

If at least one glass transition temperature of the thermoplastic polymer used for the embodiment is in the range of 30° C. to 120° C., the adhesion between the separator and electrodes and the handleability will be excellent, and it will be possible to maintain distance between the electrode surface and the separator substrate surface in the nonaqueous electrolyte solution battery, while also shortening the electrolyte solution injection time. The glass transition temperature is preferably 30° C. or higher, more preferably 40° C. or higher, even more preferably 70° C. or higher and especially preferably 95° C. or higher, from the viewpoint of the handling property and blocking resistance, and is also preferably 150° C. or lower, more preferably 130° C. or lower and especially preferably 120° C. or lower, from the viewpoint of adhesive force.

A thermoplastic polymer with two glass transition temperatures can be obtained, for example, by a method of blending two or more thermoplastic polymers, without any limitation to this method.

For a polymer blend, the glass transition temperature of the thermoplastic polymer as a whole can be controlled by combination of a polymer with a high glass transition temperature and a polymer with a low glass transition temperature. Multiple functions can also be imparted to the thermoplastic polymer as a whole. In the case of a blend, for example, both stickiness resistance and wettability with the polyolefin microporous membrane can be obtained with a blend of two or more different types of polymers having a glass transition temperature in the range of 30° C. or higher, and a polymer having a glass transition temperature in the range of 20° C. or lower. The blending ratio, in the case of a blend, is preferably in the range of 0.1:99.9 to 99.9:0.1, more preferably 5:95 to 95:5, even more preferably 50:50 to 95:5 and yet more preferably 60:40 to 90:10, as the ratio of polymers having a glass transition temperature in the range of 30° C. or higher and polymers having a glass transition temperature in the range of 20° C. or lower. The viscoelasticity can be controlled by combination of a polymer with high viscosity and a polymer with high elasticity.

For one embodiment, the glass transition temperature (Tg) of the thermoplastic polymer can be appropriately adjusted by changing the monomer components used for production of the thermoplastic polymer and the loading proportion of each monomer, for example. Specifically, the Tg for each monomer used for production of the thermoplastic polymer can be roughly estimated from the commonly used Tg for its homopolymer (as listed in “Polymer Handbook” (a Wiley-InterScience Publication), for example), and the mixing proportion of the monomer. For example, a high Tg can be obtained with a copolymer comprising a blend with a high proportion of monomers such as styrene, methyl methacrylate and acrylonitrile, which form a polymer with a Tg of about 100° C., or a low Tg can be obtained with a copolymer comprising a blend of monomers such as butadiene which forms a polymer with a Tg of about −80° C., or n-butyl acrylate and 2-ethylhexyl acrylate which form a polymer with a Tg of about −50° C.

The Tg of the polymer can be approximated by the Fox formula (formula (1) below). The glass transition point of the thermoplastic polymer of the present application is the value measured by the method using DSC described above.

$$1 / Tg = {W}_{1} / {Tg}_{1} + {W}_{2} / {Tg}_{2 +} … + Wi / Tgi + … Wn / Tgn \qquad ( 1 )$$

{In formula (1), Tg (K) represents the Tg of the copolymer, Tgᵢ (K) represents the Tg of a homopolymer of each monomer i, and Wᵢ represents the mass fraction of each monomer.}

### (Structure of Thermoplastic Polymer-Containing Layer)

In the thermoplastic polymer-containing layer, preferably a thermoplastic resin having a glass transition temperature of 30° C. to 120° C. is present on the outer surface side of the multilayer porous membrane, and a thermoplastic resin having a glass transition temperature of 20° C. or lower is present on the interface side between the polyolefin microporous membrane and the thermoplastic polymer-containing layer. The “outer surface” is the side of the thermoplastic polymer-containing layer that contacts with an electrode when the multilayer porous membrane or separator and the electrode are stacked. The “interface” is the side of the thermoplastic polymer-containing layer that contacts with the polyolefin microporous membrane or porous layer.

If a thermoplastic polymer having a glass transition temperature of 30° C. to 120° C. is present in the thermoplastic polymer-containing layer on the outer surface side of the multilayer porous membrane, the adhesiveness with the microporous membrane will be superior, and adhesiveness between the separator and electrodes will tend to be superior as a result. If a thermoplastic polymer having a glass transition temperature of 20° C. or lower is present on the interface side between the polyolefin microporous membrane and the thermoplastic polymer-containing layer, the adhesion between the separator and electrodes and the handleability will both tend to be superior. A separator having a thermoplastic polymer-containing layer as described above will tend to have further improved handleability and adhesion between the separator and electrodes.

Such a structure can be obtained as a structure in which the thermoplastic polymer (a) is composed of thermoplastic polymer particles and a binder resin that binds the thermoplastic polymer particles to the polyolefin microporous membrane with the thermoplastic polymer particles exposed on the surface, with the glass transition temperature of the thermoplastic polymer particles being in the range of 30° C. to 120° C., and a thermoplastic polymer having a glass transition temperature of 20° C. or lower being present on the interface side between the polyolefin microporous membrane and the thermoplastic polymer-containing layer, or the thermoplastic polymer (b) has a layered structure, the glass transition temperature of the thermoplastic polymer in the uppermost surface layer when used as a separator, being in the range of 30° C. to 120° C., and a thermoplastic polymer having a glass transition temperature of 20° C. or lower being present on the interface side between the polyolefin microporous membrane and the thermoplastic polymer-containing layer. The thermoplastic polymer (b) may also have a layered structure of polymers with different Tg values.

### (Mean Particle Size of Thermoplastic Polymer)

The structure of the thermoplastic polymer is not particularly restricted and may be particulate, for example. Such a structure will tend to provide more excellent adhesion between the separator and electrodes and handleability for the separator. The term “particulate” as used herein means that in measurement with a scanning electron microscope (SEM), the individual thermoplastic polymers have borders with shapes such as thin elongated, spherical or polygonal shapes.

The particle size distribution and median diameter of the thermoplastic polymer particles can be measured using a laser particle size distribution analyzer (MT3300EX Microtrac by Nikkiso Co., Ltd.). When necessary, the particle size distribution of the water or binder polymer can be used as the baseline for adjustment of the particle size distribution of the thermoplastic polymer particles. The particle size with a cumulative frequency of 50% is represented as D₅₀, and the D₅₀ of the thermoplastic polymer particles is represented as D_{P}.

The mean particle size D_{P} of the thermoplastic polymer particles is preferably 100 nm or larger, more preferably 130 nm or larger, even more preferably 320 nm or larger and most preferably 400 nm or larger, and/or preferably 1000 nm or smaller, more preferably 700 nm or smaller, even more preferably 590 nm or smaller and most preferably 550 nm or smaller, from the viewpoint of exhibiting adhesive force between the separator and electrodes while maintaining distance between multiple electrodes across the separator, and shortening the injection time for the electrolyte solution into a nonaqueous electrolyte solution battery provided with the separator.

### (Basis Weight of Thermoplastic Polymer-Containing Layer Per Side)

In the separator of one embodiment, the basis weight per side of the thermoplastic polymer-containing layer is preferably 0.03 g/m² or greater, more preferably 0.04 g/m² or greater and even more preferably 0.06 g/m² or greater, and also 0.3 g/m² or lower, more preferably 0.15 g/m² or lower and especially preferably 0.10 g/m² or lower, from the viewpoint of adhesive force. The basis weight of the thermoplastic polymer-containing layer can be adjusted by changing the polymer concentration of the solution during coating or the coating amount of the polymer solution. The preferred range for the basis weight per side of the thermoplastic polymer-containing layer is greater than 0.08 g/m², so long as the effect of the embodiment is not impeded, from the viewpoint of preventing deformation of the cell shape with expansion and contraction of the electrodes and obtaining a satisfactory cycle characteristic for the battery.

### (Thermoplastic Polymer-Containing Layer Form and Coating Percentage of Substrate Surface by Thermoplastic Polymer-Containing Layer)

The form (pattern) in which the thermoplastic polymer-containing layer is present may be mutual dispersion of the thermoplastic polymer, or a sea-island pattern, across the entire surface of the multilayer porous membrane. When the thermoplastic polymer is present in a sea-island form, the arrangement pattern may be dotted, striped, lattice-like, banded, hexagonal or random, or a combination thereof. The thermoplastic polymer-containing layer preferably has a dot pattern.

The dots are portions including the thermoplastic polymer and portions lacking the thermoplastic polymer on the polyolefin microporous membrane, the portions including the thermoplastic polymer being present as islands. The thermoplastic polymer-containing portions of the thermoplastic polymer-containing layer may also be independent.

The dot diameter of the thermoplastic polymer-containing layer is preferably 20 μm or larger, more preferably 30 μm or larger and even more preferably 40 μm or larger, and also preferably 1,200 μm or smaller, more preferably 1,100 μm or smaller and even more preferably 1,000 μm or smaller, from the viewpoint of adhesion with the PO microporous membrane or electrodes, improved strength of the multilayer porous membrane, or reduced air permeability increase with respect to the PO microporous membrane.

The distance between dots in the thermoplastic polymer-containing layer is preferably 100 μm or greater, more preferably 120 μm or greater and even more preferably 140 μm or greater, and also preferably 3,500 μm or less, more preferably 3,300 μm or less and even more preferably 3,000 μm or less, from the viewpoint of adhesion with the PO microporous membrane or electrodes, improved strength of the multilayer porous membrane, or reduced air permeability increase with respect to the PO microporous membrane.

According to one embodiment, the total coverage area ratio of the thermoplastic polymer-containing layer on the substrate surface is preferably 3% or greater, 4% or greater, 5% or greater, 10% or greater, 20% or greater, 30% or greater or 40% or greater, and preferably 90% or lower, 80% or lower, 75% or lower or 70% or lower, from the viewpoint of maintaining adhesive force of the multilayer porous membrane or separator with the electrodes while lowering the battery resistance, and of shortening the injection time for the electrolyte solution into the nonaqueous electrolyte solution battery comprising the separator. A small area coverage of the thermoplastic polymer-containing layer will result in an uneven current distribution due to non-uniform distance between the separator and the electrode interface, thereby tending to produce a temperature increase in (heat) safety testing. A large area coverage of the thermoplastic polymer-containing layer will increase the battery resistance and produce poorer results in rate testing. The total coverage area ratio S of the thermoplastic polymer-containing layer in the substrate surface is calculated by the following formula.

S(%)=Total area coverage of thermoplastic polymer-containing layer+surface area of substrate×100

The total coverage area ratio (%) of the coating pattern of the thermoplastic polymer-containing layer on the substrate surface is measured using a microscope (model: VHX-7000 by Keyence Corp.). A sample separator is photographed at 30-fold magnification (coaxial illumination), and then automatic area measurement is selected as the measuring mode for measurement of the total coverage area ratio of the thermoplastic polymer. The coverage area ratio for each sample is the arithmetic mean for three measurements.

The form or total coverage area ratio of the thermoplastic polymer-containing layer can be adjusted by changing the polymer concentration of the solution during coating or the coating amount, coating method and coating conditions for the polymer solution.

### <Properties of Multilayer Porous Membrane>

For the multilayer porous membrane of the embodiment, the ratio (T/TB) of the thickness of the porous layer (T) and the thickness (TB) of the PO microporous membrane is preferably 0.05 or higher and/or preferably 0.35 or lower. A multilayer porous membrane having a thickness ratio (T/TB) within this numerical range will allow the separator to have reduced thickness, thus not only contributing to improved productivity, but also contributing to improved energy density and safety when incorporated as a thin-film separator into a nonaqueous electrolyte solution battery. Measurement and calculation of the thickness ratio (T/TB) may be on one or both sides of the PO microporous membrane, but from the viewpoint of the action mechanism of the invention and the principle of thickness measurement, the measurement and calculation are preferably made for both sides of the PO microporous membrane, and specifically with T as the total thickness of the porous layer disposed on the multilayer porous membrane.

The heat shrinkage factor of the multilayer porous membrane after it has been allowed to stand for 1 hour in an atmosphere with a temperature of 150° C. (150° C. heat shrinkage factor), is preferably 10% or lower and more preferably 5% or lower, as the upper limit, and preferably 0% or higher as the lower limit, in both the MD and TD. A multilayer porous membrane having a 150° C. heat shrinkage factor of 10% or lower will allow the separator to have reduced thickness and high heat resistance, thus not only contributing to improved productivity, but also contributing to improved energy density and safety when incorporated as a thin-film separator into a nonaqueous electrolyte solution battery. Measurement and calculation of the 150° C. heat shrinkage factor may be made, in both the MD and TD, either under Dry conditions after allowing the multilayer porous membrane to stand for 1 hour in an oven, or under Wet conditions after immersing the multilayer porous membrane in a nonaqueous solvent such as propylene carbonate or a nonaqueous electrolyte solution containing it, and then allowing it to stand for 1 hour in an oven.

The heat shrinkage factor of the multilayer porous membrane at 140° C. (140° C. heat shrinkage factor) is preferably 10% or lower and more preferably 5% or lower, as the upper limit, and preferably 0% or higher as the lower limit, in both the MD and TD. A multilayer porous membrane having a 140° C. heat shrinkage factor of 10% or lower will allow the separator to have reduced thickness and high heat resistance, thus not only contributing to improved productivity, but also contributing to improved energy density and safety when incorporated as a thin-film separator into a nonaqueous electrolyte solution battery, thus reducing film rupture and short circuiting upon abnormal functioning of the battery. Measurement and calculation of the 140° C. heat shrinkage factor may be made, in both the MD and TD, under Wet conditions after immersing the multilayer porous membrane in a nonaqueous solvent such as propylene carbonate or a nonaqueous electrolyte solution containing it, and then allowing it to stand for 1 hour in an oven.

The heat shrinkage factor of the multilayer porous membrane at 130° C. (130° C. heat shrinkage factor) is preferably 10% or lower and more preferably 5% or lower, as the upper limit, and preferably 0% or higher as the lower limit, in both the MD and TD. The 130° C. heat shrinkage factor is preferably 10% or lower in both the MD direction and TD direction from the viewpoint of preventing film rupture of the multilayer porous membrane when battery abnormalities occur, and inhibiting short circuiting. Measurement and calculation of the 130° C. heat shrinkage factor may be made, in both the MD and TD, under Dry conditions after allowing the multilayer porous membrane to stand for 1 hour in an oven.

In order to ensure voltage endurance, the total thickness of the multilayer porous membrane is preferably 1 μm or greater, more preferably 3 μm or greater and even more preferably 5 μm or greater. The total thickness of the multilayer porous membrane is also preferably 30 μm or smaller to help prevent impairment of the capacity of the nonaqueous electrolyte solution battery in which the multilayer porous membrane is mounted, and it is more preferably 25 μm or smaller, even more preferably 20 μm or smaller and especially preferably 15 μm or smaller.

The air permeability of the multilayer porous membrane is preferably 1 sec/100 cm³ or greater, more preferably 30 sec/100 cm³ or greater and even more preferably 50 sec/100 cm³ or greater, from the viewpoint of ensuring safety for the nonaqueous electrolyte solution battery so that current does not flow excessively between the electrodes through the multilayer porous membrane. The air permeability of the multilayer porous membrane is also preferably 400 sec/100 cm³ or lower, more preferably 300 sec/100 cm³ or lower, even more preferably 200 sec/100 cm³ or lower, yet more preferably 180 sec/100 cm³ or lower, even yet more preferably 150 sec/100 cm³ or lower and most preferably 130 sec/100 cm³ or lower, from the viewpoint of ion permeability and from the viewpoint of reducing resistance to improve the capacity and cycle characteristic of the nonaqueous electrolyte solution battery.

In the multilayer porous membrane, the ratio of the air permeability of the porous layer with respect to the air permeability of the polyolefin microporous membrane (multilayer porous membrane air permeability increase ratio) is preferably such that it does not impair the air permeability of the polyolefin microporous membrane, and it is more preferably 0.01 or higher, from the viewpoint of ion permeability and the viewpoint of reducing resistance to improve the capacity and cycle characteristic of the nonaqueous electrolyte solution battery, while it is also preferably 0.40 or lower, more preferably 0.30 or lower and even more preferably 0.20 or lower, from the viewpoint of avoiding excessive flow of current between electrodes through the multilayer porous membrane, to ensure safety of the nonaqueous electrolyte solution battery.

The puncture strength of the multilayer porous membrane is preferably 0.98 N or greater, more preferably 1.47 N or greater and even more preferably 1.96 N or greater, as the lower limit, and preferably 9.81 N or lower, more preferably 5.88 N or lower and even more preferably 4.90 N or lower, as the upper limit, from the viewpoint of inhibiting tearing and of improving the safety of the nonaqueous electrolyte solution battery while maintaining membrane strength.

The multilayer porous membrane preferably has no β-crystal activity from the viewpoint of overall friction inhibition, high heat resistance, a high pin removal property and low resistance. The presence or absence of β-crystal activity in the multilayer porous membrane can be measured using a differential scanning calorimeter (DSC) or X-ray diffractometer (XRD), as necessary. A multilayer porous membrane without β-crystal activity can be obtained, for example, by a method for producing a multilayer porous membrane which includes producing a polyolefin microporous membrane, disposing a porous layer, and forming a thermoplastic polymer-containing layer, without the use of a β-crystal nucleating agent, or without addition of a β-crystal nucleating agent to the intermediate or product.

### <Method for Producing Multilayer Porous Membrane>

The multilayer porous membrane of the embodiment can be produced by a known method, and for example, it can be produced by first forming the PO microporous membrane and then disposing the porous layer on at least one side of the PO microporous membrane.

For example, if desired, the multilayer porous membrane can be produced by first forming the PO microporous membrane, and then disposing the first porous layer on one side of the PO microporous membrane and disposing the second porous layer on the other side of the PO microporous membrane. Alternatively, the PO microporous membrane and porous layer may be produced by co-extrusion, or the first porous layer and second porous layer may each be extruded onto both sides of the PO microporous membrane, or the separately produced PO microporous membrane and porous layer may be bonded together.

The method for producing a multilayer porous membrane may also include, if desired, a step of disposing a porous layer on at least one side of the PO microporous membrane to obtain a multilayer porous membrane, and forming a thermoplastic polymer-containing layer on at least one side of the obtained multilayer porous membrane.

### (Method for Producing Polyolefin Microporous Membrane)

The method for producing the polyolefin microporous membrane (PO microporous membrane) is not particularly restricted, and any known production method may be employed.

Methods for producing polyolefin microporous membranes are largely divided into wet methods and dry methods. In a wet method, extractable matter is added to and dispersed in a polyolefin and the dispersion is cast, after which the extractable matter is extracted using a liquid such as a solvent to form pores. Examples of dry methods include (a) a method in which an unstretched body is formed which has formed a crystal lamellar structure during melt extrusion casting, and pores are then formed by lamellar cleavage primarily by uniaxial stretching, and (b) a method in which incompatible particles such as inorganic particles are added to a polyolefin and the mixture is stretched in order to detach the interfaces between the different types of materials and form pores.

The method for producing the PO microporous membrane for this embodiment may be either a wet method or a dry method, and from the viewpoint of reducing friction on the multilayer porous membrane as a whole, and of high heat resistance, a high pin removal property and low resistance, for a dry method, it is preferred not to use a β-crystal method (in which β-crystals with low crystal density are produced in the melt extruded molded resin, crystal transition to α-crystals which have high crystal density is induced by stretching, and pores are formed by the difference in crystal density of the two), and during the production process for the PO microporous membrane, preferably no β-crystal nucleating agent is used, no β-crystal nucleating agent starting material is added to the intermediate or product, and β-crystal nucleating agents are avoided or removed by continuing observation in the manufacturing line.

Examples of methods for producing a PO microporous membrane for the embodiment include:
(1) a method of melt kneading a polyolefin resin composition and a pore-forming material and molding the mixture into a sheet, with stretching if necessary, and then extracting the pore-forming material to form pores,
(2) a method of melt kneading a polyolefin resin composition, extruding it at a high draw ratio, and then stretching it with heat treatment to detach the polyolefin crystal interface and form pores,
(3) a method of melt kneading a polyolefin resin composition and an inorganic filler and casting the mixture onto a sheet, and then detaching the interface between the polyolefin and the inorganic filler by stretching to form pores, and
(4) a method of first dissolving the polyolefin resin composition, and then dipping it in a poor solvent for the polyolefin to solidify the polyolefin while simultaneously removing the solvent, to form pores.

An example of a method of producing the PO microporous membrane will now be described, as a method of melt kneading a polyolefin resin composition and a pore-forming material, casting the mixture into a sheet, and then extracting the pore-forming material.

First, the polyolefin resin composition and the pore-forming material are melt-kneaded. In the melt kneading method, a polyolefin resin and other additives as necessary may be loaded into a resin kneader such as an extruder, feeder, Laboplastomil, kneading roll or Banbury mixer, and the pore-forming material may then be introduced at a desired proportion and kneaded in while hot melting the resin components.

The pore-forming material may be a plasticizer, an inorganic material, or a combination thereof. The plasticizer is not particularly restricted, and may be a non-volatile solvent that can form a homogeneous solution at above the melting point of the polyolefin, such as a hydrocarbon such as liquid paraffin or paraffin wax; an ester such as dioctyl phthalate or dibutyl phthalate; or a higher alcohol such as oleyl alcohol or stearyl alcohol. Liquid paraffins are preferred among these plasticizers because of their high compatibility when the polyolefin resin is polyethylene and/or polypropylene, and low risk of interfacial peeling between the resin and plasticizer even when the melt kneaded mixture is stretched, tending to allow homogeneous stretching. Examples of inorganic materials include oxide-based ceramics such as alumina, silica (silicon oxide), titania, zirconia, magnesia, ceria, yttria, zinc oxide and iron oxide; nitride-based ceramics such as silicon nitride, titanium nitride and boron nitride; ceramics such as silicon carbide, calcium carbonate, aluminum sulfate, aluminum hydroxide, potassium titanate, talc, kaolin clay, kaolinite, halloysite, pyrophyllite, montmorillonite, sericite, mica, amesite, bentonite, asbestos, zeolite, calcium silicate, magnesium silicate, diatomaceous earth and quartz sand; and glass fibers. These may be used alone or as combinations of two or more types. Of the inorganic materials, silica, alumina and titania are preferred from the viewpoint of electrochemical stability, and silica is especially preferred from the viewpoint of easier extraction.

The melt kneaded mixture is then cast into a sheet. The method of producing the cast sheet may be, for example, a method of extruding the melt kneaded mixture through a T-die or the like into a sheet, and contacting it with a heat conductor to cool it to a sufficiently lower temperature than the crystallization temperature of the resin component, thereby solidifying it. The heat conductor used for cooling solidification may be a metal, water, air or a plasticizer. Metal rolls are preferably used for high heat conduction efficiency. When the extruded kneaded blend is to be contacted with metal rolls, it is more preferably sandwiched between the rolls because this will further increase the heat conduction efficiency while causing the sheet to become oriented and increasing the membrane strength, and also tending to improve the surface smoothness of the sheet. The die lip gap when extruding the melt kneaded mixture into a sheet from a T-die is preferably 200 μm or larger and more preferably 500 μm or larger, and preferably 3,000 μm or smaller and more preferably 2,500 μm or smaller. Limiting the die lip gap to 200 μm or greater can reduce tip adhesion, can lower the effects of streaks and defects on the film quality, and can lower the risk of film rupture during the subsequent stretching step. Limiting the die lip gap to 3,000 μm or smaller, on the other hand, can speed the cooling rate to prevent cooling irregularities while maintaining sheet thickness stability.

The cast sheet may also be subjected to rolling. Rolling may be carried out, for example, by a press method using a double belt press machine or the like. Rolling can increase the orientation of the surface layer sections, in particular. The area increase by rolling is preferably by a factor of greater than 1 and no greater than 3, and more preferably a factor of greater than 1 and no greater than 2. If the rolling factor exceeds 1, the plane orientation will increase and the membrane strength of the final porous membrane will tend to increase. If the rolling factor is 3 or lower, there will be less of a difference in orientation between the surface layer portion and center interior portion, tending to allow formation of a porous structure that is more uniform in the thickness direction of the membrane.

The pore-forming material is then removed from the cast sheet to obtain a porous membrane. The method of removing the pore-forming material may be, for example, a method of immersing the cast sheet in an extraction solvent to extract the pore-forming material, and then thoroughly drying it. The method of extracting the pore-forming material may be either a batch process or a continuous process. In order to minimize shrinkage of the porous membrane, it is preferred to constrain the edges of the cast sheet during the series of steps of immersion and drying. The residue of the pore-forming material in the porous membrane is preferably less than 1 weight % of the total weight of the porous membrane.

The extraction solvent used for extraction of the pore-forming material is preferably a poor solvent for the polyolefin resin and a good solvent for the pore-forming material, and one having a boiling point that is lower than the melting point of the polyolefin resin. Examples of such extraction solvents include hydrocarbons such as n-hexane and cyclohexane; halogenated hydrocarbons such as methylene chloride and 1,1,1-trichloroethane; non-chlorine-based halogenated solvents such as hydrofluoroethers and hydrofluorocarbons; alcohols such as ethanol and isopropanol; ethers such as diethyl ether and tetrahydrofuran; and ketones such as acetone and methyl ethyl ketone. These extraction solvents may be collected by a process such as distillation and then reutilized. When an inorganic material is used as the pore-forming material, an aqueous solution of sodium hydroxide or potassium hydroxide may be used as the extraction solvent.

The cast sheet or porous membrane is preferably also stretched. Stretching may also be carried out before extraction of the pore-forming material from the cast sheet. It may also be carried out on the porous membrane after the pore-forming material has been extracted from the cast sheet. Stretching may be carried out before and after extraction of the pore-forming material from the cast sheet.

Either uniaxial stretching or biaxial stretching can be suitably used for the stretching treatment, but biaxial stretching is preferred from the viewpoint of improving the strength of the obtained PO microporous membrane. When a cast sheet is subjected to high-ratio stretching in the biaxial directions, the molecules become oriented in the in-plane direction, such that the microporous membrane that is obtained as the final result is less likely to tear, and has high puncture strength.

Examples of stretching methods include simultaneous biaxial stretching, sequential biaxial stretching, multistage stretching and repeated stretching. Simultaneous biaxial stretching is preferred from the viewpoint of increasing the puncture strength and obtaining greater uniformity during stretching and superior shutdown properties. Successive biaxial stretching is preferred from the viewpoint of facilitating control of the planar orientation.

Simultaneous biaxial stretching is a stretching method in which stretching in the MD and stretching in the TD are carried out simultaneously, and in such a case the stretch ratios in each direction may be different. Sequential biaxial stretching is a stretching method in which stretching in the MD and TD are carried out independently, in such a manner that when MD or TD stretching is being carried out, the other direction is in a non-constrained state or in an anchored state with fixed length.

The stretch ratio is preferably at least 20-fold and more preferably at least 25-fold as the area increase, and preferably 100-fold or less and more preferably 70-fold or less as the area increase. The stretch ratio in each axial direction is preferably at least 4-fold in the MD and at least 4-fold in the TD, more preferably at least 5-fold in the MD and at least 5-fold in the TD, and also preferably 10-fold or less in the MD and 10-fold or less in the TD, and more preferably 8-fold or less in the MD and 8-fold or less in the TD. If the total area factor is 20 or greater the obtained PO microporous membrane will tend to be imparted with sufficient strength, and if the total area factor is 100 or lower, membrane rupture will tend to be prevented in the stretching step, resulting in high productivity.

In order to help prevent shrinkage of the PO microporous membrane, heat treatment for heat setting may be carried out either after the stretching step or after formation of the PO microporous membrane. The PO microporous membrane may also be subjected to post-treatment such as hydrophilicizing treatment with a surfactant, or crosslinking treatment with ionizing radiation.

From the viewpoint of inhibiting shrinkage, the PO microporous membrane is preferably subjected to heat treatment for heat setting. The method of heat treatment may include a stretching procedure carried out with a predetermined temperature atmosphere and a predetermined stretch ratio to adjust the physical properties, and/or a relaxation procedure with a predetermined temperature atmosphere and a predetermined relaxation factor to reduce the stretching stress. The relaxation procedure may also be carried out after the stretching procedure. Such heat treatment can be carried out using a tenter or roll stretcher.

From the viewpoint of obtaining a PO microporous membrane with higher strength and higher porosity, the stretching procedure is preferably stretching to a factor of 1.1 or greater and more preferably to a factor of 1.2 or greater in the MD and/or TD of the membrane.

The relaxation procedure is contraction in the MD and/or TD of the membrane. The relaxation factor is the value of the dimension of the membrane after relaxation divided by the dimension of the membrane before the relaxation. When relaxation is in both the MD and TD, it is the value of the relaxation factor in the MD multiplied by the relaxation factor in the TD. The relaxation factor is also preferably 1.0 or lower, more preferably 0.97 or lower and even more preferably 0.95 or lower. The relaxation factor is preferably 0.5 or higher from the viewpoint of membrane quality. The relaxation procedure may be carried out in both the MD and TD, or in only either of the MD or TD.

The stretching and relaxation procedures after extraction of the plasticizer are preferably carried out in the TD from the viewpoint of process control and of controlling the open hole area in 400° C. solder testing. The temperature during the stretching and relaxation procedures is preferably lower than the melting point (hereunder, “Tm”) of the polyolefin resin, and more preferably in the range of 1° C. to 25° C. lower than the Tm. The temperatures for the stretching and relaxation procedures are preferably within this range from the viewpoint of balance between heat shrinkage factor reduction and porosity.

### (Method for Disposing Porous Layer)

The method of disposing the porous layers on at least one side of the PO microporous membrane may be a known disposing method, coating method, lamination method or extrusion method. For example, the PO microporous membrane may be coated with a coating solution or slurry containing the inorganic particles explained above, and optionally a resin binder and/or dispersing agent, to form a porous layer.

A method used to dispose the first porous layer on one side of the PO microporous membrane and to dispose the second porous layer on the other side of the PO microporous membrane may also be a known disposing method, coating method, lamination method or extrusion method. As another example, both sides of the PO microporous membrane may be coated with a coating solution or slurry containing the inorganic particles explained above, and optionally a resin binder and/or dispersing agent, to form a porous layer.

From the viewpoint of the relationship with the surface friction coefficient of the porous layer as explained above, for the process of disposing the porous layer, the type of inorganic particle material is preferably selected based on the stress relaxation rate in a shearing test, and from the viewpoint of facilitating control of μₛ and/or μ′ₛ of the porous layer it is preferred to use barium sulfate, and more preferably barium sulfate obtained by the sulfuric acid method.

The percentage of inorganic particles is preferably greater than 70 vol %, more preferably greater than 75 vol %, even more preferably greater than 80 vol % yet more preferably greater than 85 vol % and especially preferably greater than 90 vol %, and also preferably 95 vol % or lower, more preferably 93 vol % or lower, even more preferably 92 vol % or lower and especially preferably 91 vol % or lower, as the upper limit, with 100 vol % as the total of the inorganic particles, resin binder and dispersing agent in the coating solution or slurry. If the volume ratio of the inorganic particles in the coating solution is within this range, the proportion of inorganic particles with respect to the other components such as the resin binder will increase, thereby facilitating adjustment of the surface friction coefficient of the porous layer as explained above, and inhibiting increase in air permeability of the PO microporous membrane due to the porous layer, lowering the electrical resistance of the multilayer porous membrane, and contributing to high levels for low friction, high heat-resistance and low resistance of the multilayer porous membrane.

In addition, from the same viewpoint as for the volume ratio explained above, the weight ratio of inorganic particles making up the coating solution or slurry is preferably greater than 80 weight %, more preferably greater than 90 weight %, even more preferably 93 weight % or greater, yet more preferably 95 weight % or greater and especially preferably 97 weight % or greater, with 100 weight % as the total of the inorganic particles, resin binder and dispersing agent. The upper limit for the weight ratio of the inorganic particles in the coating solution or slurry is not particularly restricted, and may be 100 weight % or lower, lower than 100 weight % or 99% weight or lower, for example.

The particle size distribution in the inorganic particle-containing coating solution or slurry preferably satisfies one or more of the following relationships for the mean particle size D₅₀:

0.01 μm≤D₅₀<0.60 μm,

0.01 μm≤D₅₀≤0.50 μm,

0.10 μm≤D₅₀≤0.45 μm,

0.20 μm≤D≤₅₀≤0.40 μm,

0.25 μm≤D₅₀≤0.35 μm,

from the viewpoint of the relationship with the surface friction coefficient of the porous layer explained above, and from the viewpoint of strengthening interaction between the inorganic particles and other components to further increase the heat shrinkage inhibiting ability and strength of the multilayer porous membrane and the capacity and cycle characteristic of the nonaqueous electrolyte solution battery.

The method of adjusting the particle size distribution of the inorganic particle-containing coating solution or slurry may be, for example, a method of pulverizing barium sulfate using a ball mill, bead mill or jet mill to obtain the desired particle size distribution, or a method of preparing barium sulfates with different particle size distributions as inorganic fillers and then blending them.

For formation of the inorganic particle-containing slurry or coating solution, the ratio (Wb′/Wa′) between the weight ratio Wa′ of the water-soluble binder and the weight ratio Wb′ of the water-insoluble binder in the slurry or coating solution is preferably 1.0 or lower, more preferably 0.5 or lower and even more preferably 0.3 or lower, and also preferably 0 or higher, or higher than 0, as the lower limit, from the viewpoint of interaction between the water-soluble polymer such as poly(meth)acrylamide and the barium sulfate, of increasing the number of contact points between them, and of heat resistance of the multilayer porous membrane or separator.

For improved dispersion stability or coatability, a dispersing agent such as a surfactant may also be added to the inorganic particle-containing coating solution or slurry. The dispersing agent is adsorbed onto the surfaces of the inorganic particles in the slurry, thus stabilizing the inorganic particles by electrostatic repulsion or other forces, and examples thereof include polycarboxylic acid salts, sulfonic acid salts and polyoxyethers. The amount of dispersing agent added is preferably 0.2 parts by weight or greater and more preferably 0.3 parts by weight or greater as solid content, and also preferably 5.0 parts by weight or lower and more preferably 1.0 parts by weight or lower as solid content.

Various additives such as thickeners; moistening agents; antifoaming agents; or acid- or alkali-containing pH adjustors, may also be added to the coating solution to improve the dispersion stability or coatability and to adjust the contact angle on the surface of the porous layer. The total amount of such additives, in terms of active ingredient (weight of the dissolved additive component, when the additive is dissolved in a solvent) with respect to 100 parts by weight of the inorganic particles, is preferably 20 parts by weight or lower, more preferably 10 parts by weight or lower and even more preferably 5 parts by weight or lower.

Examples of anionic surfactant additives include higher fatty acid salts, alkylsulfonates, α-olefin sulfonates, alkane sulfonates, alkyl benzenesulfonates, sulfosuccinic acid ester salts, alkylsulfuric acid ester salts, alkyl ether sulfuric acid ester salts, alkylphosphoric acid ester salts, alkyl ether phosphoric acid ester salts, alkyl ether carboxylates, α-sulfo fatty acid methyl ester salts and methyltaurine acid salts. Examples of nonionic surfactants include glycerin fatty acid esters, polyglycerin fatty acid esters, sucrose fatty acid esters, sorbitan fatty acid esters, polyoxyethylene sorbitan fatty acid esters, polyoxyethylene alkyl ethers, polyoxyethylene alkylphenyl ethers, polyoxyethylene fatty acid esters, fatty acid alkanolamides and alkyl glucosides. Examples of amphoteric surfactants include alkyl betaines, fatty acid amide propyl betaine and alkylamine oxides. Examples of cationic surfactants include alkyltrimethylammonium salts, dialkyldimethylammonium salts, alkyldimethylbenzylammonium salts and alkylpyridinium salts. Other examples include fluorine-based surfactants, and polymer surfactants such as cellulose derivatives, polycarboxylic acid salts and polystyrenesulfonic acid salts.

The medium for the coating solution is preferably one that can uniformly and stably dissolve or disperse the inorganic particles or resin binder, and examples include N-methylpyrrolidone, N,N-dimethylformamide, N,N-dimethyl acetamide, water, ethanol, toluene, hot xylene, methylene chloride and hexane.

The method of dissolving or dispersing the inorganic particles and resin binder in the coating solution medium is not particularly restricted so long as it allows the coating solution to exhibit the necessary dispersion properties for the coating step. Examples include mechanical stirring using a ball mill, bead mill, planetary ball mill, vibrating ball mill, sand mill, colloid mill, attritor, roll mill, high-speed impeller disperser, disperser, homogenizer, high-speed impact mill, ultrasonic disperser or stirring blade.

The method of coating the barium sulfate-containing coating solution or barium sulfate-containing slurry onto the PO microporous membrane is not particularly restricted so long as the necessary layer thickness or coating area can be ensured, and examples include gravure coater methods, small-diameter gravure coater methods, reverse roll coater methods, transfer roll coater methods, kiss coater methods, dip coater methods, knife coater methods, air doctor coater methods, blade coater methods, rod coater methods, squeeze coater methods, cast coater methods, die coater methods, screen printing methods and spray coating methods.

According to one embodiment, coating of the barium sulfate-containing coating solution or barium sulfate-containing slurry onto the PO microporous membrane is carried out to a coating thickness of preferably 4 μm or smaller, more preferably smaller than 3 am, even more preferably smaller than 2.5 am, yet more preferably 2.4 am or smaller, especially preferably 2.0 μm or smaller and most preferably 1.5 μm or smaller, and also preferably 0.1 μm or larger, more preferably 0.5 μm or larger, even more preferably 0.7 μm or larger and most preferably 1.0 μm or larger as the lower limit, for the porous layer on at least one side of the PO microporous membrane, from the viewpoint of inhibiting increase in air permeability of the PO microporous membrane, forming a firm porous layer, and thickness reduction and heat resistance (heat shrinkage inhibiting ability) of the obtained multilayer porous membrane or separator.

According to one embodiment, coating of the inorganic particle-containing coating solution or slurry onto the PO microporous membrane is carried out to a porous layer coated basis weight of preferably 1.0 g/m² or greater and more preferably 1.5 g/m² or greater, and preferably 5.0 g/m² or lower and more preferably 4.0 g/m² or lower, from the viewpoint of the action mechanism of the invention.

The PO microporous membrane may also optionally be surface treated before application of the inorganic particle-containing coating solution or slurry. Surface treatment of the PO microporous membrane can aid in application of the coating solution or slurry, and may also increase adhesion between the barium sulfate-containing porous layer and the PO microporous membrane surface after coating. The method of surface treatment is not particularly restricted so long as it does not significantly impair the porous structure of the PO microporous membrane, and examples include corona discharge treatment, plasma discharge treatment, mechanical roughening methods, solvent treatment and ultraviolet ray oxidation methods.

The method of removing the medium from the coated film after application is also not particularly restricted so long as it does not adversely affect the PO microporous membrane, and examples include methods of anchoring the PO microporous membrane while drying it at a temperature below its melting point, methods of reduced pressure drying at low temperature, and methods of extraction drying. Some of the solvent may be allowed to remain so long as it does not produce any notable effect on the properties of the nonaqueous electrolyte solution battery. The multilayer porous membrane having the porous layer laminated on the PO microporous membrane preferably has its drying temperature and take-up tension appropriately adjusted from the viewpoint of controlling shrinkage stress in the MD direction.

It is preferred to use no β-crystal nucleating agent, to not add a β-crystal nucleating agent material to the intermediate or product, and to prevent or avoid inclusion of β-crystal nucleating agent by continuing observation in the manufacturing line during the process of disposing the porous layer, from the viewpoint of reducing friction on the multilayer porous membrane as a whole, and of high heat resistance, a high pin removal property and low resistance.

### (Method of Forming Thermoplastic Polymer-Containing Layer)

The method for forming the thermoplastic polymer-containing layer on the PO microporous membrane or porous layer as the substrate is not particularly restricted, and an example is a method of coating the PO microporous membrane or porous layer with a coating solution comprising the thermoplastic polymer.

The method of applying the coating solution comprising the thermoplastic polymer onto the PO microporous membrane or porous layer is not particularly restricted so long as it can provide the necessary layer thickness and coating area. Examples include gravure coater methods, small-diameter gravure coater methods, reverse roll coater methods, transfer roll coater methods, kiss coater methods, dip coater methods, knife coater methods, air doctor coater methods, blade coater methods, rod coater methods, squeeze coater methods, cast coater methods, die coater methods, screen printing methods, spray coating methods, spray coater methods and ink-jet coating methods. Preferred among these are gravure coater methods or spray coating methods, from the viewpoint of a high degree of freedom for the coating shape of the thermoplastic polymer, to easily obtain the preferred area ratio. For formation of a dot pattern of the thermoplastic polymer-containing layer, preferred methods are gravure coating, ink-jet application and coating methods that allow easy adjustment of the printing plate.

If the coating solution infiltrates to the interior of the microporous membrane or porous layer when the thermoplastic polymer is coated on the PO microporous membrane, the adhesive resin will become embedded on the surfaces and interiors of the pores, lowering the permeability. The medium of the coating solution is therefore preferably a poor solvent for the thermoplastic polymer.

A poor solvent for the thermoplastic polymer is preferably used as the medium of the coating solution, from the viewpoint of inhibiting reduction in permeability, since the coating solution will fail to infiltrate into the microporous membrane or porous layer and the adhesive polymer will be present mainly on the surface of the microporous membrane. Water is preferred as a medium with such properties. Media that can be used in combination with water include, but are not particularly restricted to, ethanol and methanol. An antifoaming agent may also be optionally added to the thermoplastic polymer-containing coating solution.

From the viewpoint of adhesion between the separator and the electrodes, and the viewpoint of impeding temperature increase of the separator and impeding cycle degradation for further adaptability to high-temperature storage testing, the coating material viscosity of the thermoplastic polymer-containing coating solution (hereunder also referred to as “coating material”) is preferably 30 cP or higher and more preferably 50 cP or higher, and preferably 100 cP or lower and more preferably 80 cP or lower. From the same viewpoint, the pH of the coating material is preferably 5 or higher and more preferably 5.5 or higher, and preferably 7.9 or lower and more preferably 7.7 or lower.

Surface treatment of the microporous membrane serving as the separator substrate is also preferably carried out before coating, in order to facilitate application of the coating solution and increased adhesion between the microporous membrane or porous layer and the adhesive polymer. The method of surface treatment is not particularly restricted so long as it does not significantly impair the porous structure of the microporous membrane, and examples include corona discharge treatment, plasma treatment, mechanical roughening methods, solvent treatment, acid treatment and ultraviolet oxidation.

For corona discharge treatment, the intensity of corona treatment on the substrate surface is preferably 1 W/(m²/min) or greater, more preferably 3 W/(m²/min) or greater and even more preferably 5 W/(m²/min) or greater, and also preferably 40 W/(m²/min) or lower, more preferably 32 W/(m²/min) or lower and even more preferably 25 W/(m²/min) or lower.

The method of removing the solvent from the coated film after coating is not particularly restricted so long as it is a method that does not adversely affect the microporous membrane or porous layer. For example, it may be a method of drying the microporous membrane and/or porous layer at a temperature below its melting point while anchoring it, a method of reduced pressure drying at low temperature, or a method of immersing it in a poor solvent for the adhesive polymer to solidify the adhesive polymer while simultaneously extracting out the solvent.

For drying of the coated film, the drying speed is preferably 0.03 g/(m²·s) or greater, more preferably 0.05 g/(m²·s) or greater and even more preferably 0.08 g/(m²·s) or greater, and preferably 4.0 g/(m²·s) or lower, more preferably 3.5 g/(m²·s) or lower and even more preferably 3.0 g/(m²·s) or lower. The temperature is preferably increased by warming or heating during drying of the coated film, to an extent that does not degrade the particle shapes in the thermoplastic polymer-containing layer.

### <Nonaqueous Electrolyte Solution Battery Separator and Nonaqueous Electrolyte Solution Battery>

The multilayer porous membrane of the embodiment can be used as a nonaqueous electrolyte solution battery separator. The nonaqueous electrolyte solution battery comprises a positive electrode, a separator, a negative electrode and a nonaqueous electrolyte solution, and specifically, it may be a lithium battery, lithium secondary battery, lithium ion secondary battery, sodium secondary battery, sodium ion secondary battery, magnesium secondary battery, magnesium ion secondary battery, calcium secondary battery, calcium ion secondary battery, aluminum secondary battery, aluminum ion secondary battery, nickel-hydrogen battery, nickel-cadmium battery, electrical double layer capacitor, lithium ion capacitor, redox flow battery or lithium-sulfur battery, for example. Preferred among these, from the viewpoint of practicality, is a lithium battery, lithium secondary battery, lithium ion secondary battery, nickel-hydrogen battery or lithium ion capacitor, with a lithium ion secondary battery being more preferred.

A nonaqueous electrolyte solution battery can be fabricated, for example, by stacking a positive electrode and negative electrode across a separator comprising a multilayer porous membrane as described above, if necessary winding or folding it in a hairpin fashion to form a stacked electrode body, wound electrode body or hairpin-folded body, and then packing it in an exterior body, connecting the positive and negative electrodes and the positive and negative electrode terminals of the exterior body via leads or the like, injecting a nonaqueous electrolyte solution containing a nonaqueous solvent such as a straight-chain or cyclic carbonate and an electrolyte such as a lithium salt into the exterior body, and finally sealing the exterior body.

The nonaqueous electrolyte solution battery comprises a stacked body as described above, a wound body obtained by winding the stacked body, or a hairpin-folded body obtained by hairpin-folding the stacked body, together with a nonaqueous electrolyte solution, inside an exterior body such as a cylindrical can, a pouch-type case or a laminate case. A nonaqueous electrolyte solution battery using the multilayer porous membrane of the embodiment as a separator may exhibit not only excellent safety but also excellent energy density and cycle characteristics.

When the nonaqueous electrolyte solution battery is a secondary battery, a positive electrode terminal may be welded to the edge of a positive electrode stacked body comprising a positive electrode collector and a positive electrode active material layer, while a negative electrode terminal may be welded to the edge of a negative electrode stacked body comprising a negative electrode collector and a negative electrode active material layer, so that a secondary battery comprising a terminal-attached positive electrode stacked body and a terminal-attached negative electrode stacked body can be subjected to charge-discharge.

The terminal-attached positive electrode stacked body and the terminal-attached negative electrode stacked body may then be stacked across a separator and optionally wound or hairpin-folded, and the obtained stacked body, wound body or hairpin-folded body may be housed in an exterior body, with injection of a nonaqueous electrolyte solution into the exterior body and sealing of the exterior body, to obtain a secondary battery.

When the multilayer porous membrane of the embodiment is to be used as a separator for production of a nonaqueous electrolyte solution secondary battery, the positive electrode, negative electrode and nonaqueous electrolyte solution used may be known ones.

The positive electrode material is not particularly restricted, and examples include lithium-containing composite oxides such as LiCoO₂, LiNiO₂, spinel-type LiMnO₄ and olivine-type LiFePO₄.

The negative electrode material is also not particularly restricted, and examples include carbon materials such as graphite, non-graphitizable carbon, easily graphitizable carbon and complex carbon; or silicon, tin, metal lithium and various alloy materials.

There are no particular restrictions on the nonaqueous electrolyte solution, and an electrolyte solution comprising an electrolyte dissolved in an organic solvent may be used. Examples of organic solvents include propylene carbonate, ethylene carbonate, dimethyl carbonate, diethyl carbonate and ethylmethyl carbonate. Examples of electrolytes include lithium salts such as LiClO₄, LiBF₄ and LiPF₆.

### EXAMPLES

The present invention will now be explained in detail through Examples and Comparative Examples, with the understanding that these Examples and Comparative Examples are not limitative on the invention.

### Testing and Evaluation Methods

### <Viscosity-Average Molecular Weight (Mv)>

The limiting viscosity [η] (dl/g) at 135° C. in a decalin solvent was determined based on ASTM-D4020.

The My for the polyethylene and polyolefin microporous membrane were calculated by the following formula.

$$[ η ] = 6.77 \times {10}^{- 4} {Mv}^{0.67}$$

For polypropylene, the My was calculated by the following formula.

$$[ η ] = 1.10 \times 1 {0}^{- 4} {Mv}^{0.8}$$

<Thickness of Polyolefin Microporous Membrane, Multilayer Porous Membrane and Porous Layer (μm)>

A “KBM™”, microthickness meter by Toyo Seiki Co., Ltd. was used to measure the thicknesses of the polyolefin microporous membrane and multilayer porous membrane at room temperature (23±2° C.), and the coating thicknesses of the porous layers were each calculated from the measured thicknesses. The cross-sectional SEM image may also be used to measure the thickness of each layer, as values by detection from the multilayer porous membrane.

<Melt Index (MI) (g/10 Min) of Polyolefin Microporous Membrane>

The melt index (MI) of the polyolefin microporous membrane (PO microporous membrane) was measured according to JIS K7210:1999 (Plastic-thermoplastic melt mass-flow rate (MFR) and melt volume flow rate (MVR)). A 21.6 kgf load was placed on the membrane at 190° C., and the amount of resin (g) exuding in 10 minutes from an orifice with a diameter of 1 mm and a length of 10 mm was measured, recording the MI as the value with the first decimal place rounded upward.

### <Mean Particle Size and Particle Size Distribution of Inorganic Particles>

For the particle size distribution and median diameter (μm) of the inorganic particle dispersion or slurry coating solution, the particle size distribution of the inorganic particle dispersion or slurry coating solution was measured using a laser particle size distribution analyzer (Microtrac MT3300EX by Nikkiso Co., Ltd.). When necessary, the particle size distribution of water or the resin binder was used as the baseline for adjustment of the particle size distribution of the inorganic particle dispersion or slurry coating solution. The particle size where the cumulative frequency was 50% was recorded as D₅₀.

<BET Specific Surface Area of Inorganic Particles (m²/g)>

The specific surface area of the inorganic particles was measured by the nitrogen adsorption BET method.

### <Stress Relaxation Rate of Inorganic Particles>

An NS-S500 powder bed shear force tester (Nano Seeds Corp.) was used for measurement in a room temperature atmosphere. The apparatus basically consists of a measuring apparatus body and a control box. The measuring apparatus body comprises a powder bed shear cell, a pressurizing unit and a linear actuator, while the control box comprises instrument amplifiers and a control computer. The panel used was carbide (surface-polished, G5 material).

The sample was filled into the shear cell and the top surface of the powder bed was flattened, after which an indentation load of 40 N was applied and the stress relaxation rate was calculated by the following formula.

$$Stress relaxation rate = ( indentation load - ( load 100 second after reaching indentation load ) ) / ( indentation load ) \times 100$$

<Air Permeability (See/100 cm³), and Air Permeability Ratio of Multilayer Porous Membrane with Respect to Polyolefin Microporous Membrane>

The air permeability of the multilayer porous membrane and the air permeability of the polyolefin microporous membrane, where the air permeability is defined as the air permeability resistance according to JIS P-8117, were measured using a “G-B2™”, Gurley air permeability tester by Toyo Seiki Kogyo Co., Ltd. according to JIS P-8117, measuring the air permeability resistance of the multilayer porous membrane and polyolefin microporous membrane in an atmosphere with a temperature of 23° C. and a humidity of 40%.

The value of the air permeability of the multilayer porous membrane minus the air permeability of the polyolefin microporous membrane was calculated as the air permeability of the porous layer. The increase in air permeability was also calculated by the following formula:

Air permeability increase=Air permeability of porous layer/air permeability of polyolefin microporous membrane.

The air permeability per thickness of the porous layer was also calculated.

### <Inorganic Particle Content (Weight % and Vol %) in Porous Layer>

The inorganic particle content in the porous layer was calculated from the mixing ratio of the constituent materials during preparation of the coating solution.

For detection from the multilayer porous membrane, a TG-DTA may be used to measure the changes in weights of the organic materials and inorganic particles. Specifically, a portion of the porous layer is scraped off from the multilayer porous membrane with a glass plate to obtain an 8 mg to 10 mg sample. The porous layer sample is set in the apparatus and the change in weight is measured in an air atmosphere while raising the temperature from room temperature to 600° C. at a temperature-elevating rate of 10° C./min, and used for calculation. The weight content ratio and volume content ratio of the inorganic particles are interchangeable based on the specific gravity of the inorganic particles.

### <Porosity (%)>

A 10 cm×10 cm-square sample was cut out from the microporous membrane, and its volume (cm³) and mass (g) were determined and used together with the membrane density (g/cm³) by the following formula, to obtain the porosity.

$$Porosity ( \% ) = ( Volume - mass / density ) / volume \times 100$$

### <Measurement of Surface Friction Coefficient of Porous Layer>

### (Friction Test)

On the side of the separator sample on which the porous layer was formed, an MH-3 friction tester by Toyo Seiki Seisakusho, Ltd. was used under conditions with a thread mass of 200 g, a load range of 2 N, a contact area of 63 mm×63 mm (felt material), a contact feed speed of 100 mm/min, a temperature of 23° C. and 50% humidity, to determine the static friction coefficient as the maximum within a measuring distance of 5 mm and the dynamic friction coefficient as the value at a measuring distance of 300 mm, performing measurement 3 times in the MD or TD and taking the average to calculate each frictional coefficient.

The SUS sheet used for measurement was a table made of a SUS304 6F finished product (pre-processing: plate milling, special #200 buff+nitriding+finishing; buff finishing: polishing in coordinated processing direction (widthwise processing), thread size special #200 (tolerance: about #200 to about #230)).

### <Puncture Strength (N) and Basis Weight-Equivalent Puncture Strength (N/(g/m²))>

Using a Handy Compression Tester “KES-G5 ™” by Kato Tech Corp., the microporous membrane or multilayer porous membrane was anchored with a specimen holder having an opening diameter of 11.3 mm. Next, the center section of the anchored microporous membrane or multilayer porous membrane was subjected to a puncture test with a needle having a tip curvature radius of 0.5 mm, at a puncture speed of 2 mm/sec and in an atmosphere with a temperature of 23° C. and a humidity of 40%, the raw puncture strength (gf) being obtained as the maximum puncture load. The value of the obtained puncture strength (N) in terms of basis weight (N/(g/m²)) was also calculated.

### <Dry Heat Shrinkage Factor (%) at 130° C. and 150° C.>

A multilayer porous membrane sample was cut out to 100 mm in the MD direction and 100 mm in the TD direction, and allowed to stand for 1 hour in an oven at 130° C. or 150° C. During this time, the sample was sandwiched between ten sheets of paper so as to avoid direct contact of the sample with warm air. After removing the sample from the oven and cooling it, the length (mm) was measured and the heat shrinkage factor was calculated by the following formula. Measurement was performed in the MD and TD, representing the heat shrinkage factors as the averages for each.

$$Heat shrinkage factor ( \% ) = \{ ( 100 - length after heating ) / 100 \} \times 100$$

### <Wet Heat Shrinkage Factor (%) at 140° C.>

The multilayer porous membrane was cut to 50 mm in the MD and 50 mm in the TD, and sandwiched with TEFLON™ sheets (100 μm thickness, 60 mm square). The stack was housed in a package composed of an aluminum laminate film (35 μm thickness, 100 mm square), 0.5 mL of propylene carbonate was injected and the multilayer porous membrane was soaked with the propylene carbonate, sealing the remaining side, to prepare a sample. Each sample was stored stationary for 24 hours and then left to stand for 1 hour in an oven at 140° C. After removing the sample from the oven and cooling it, the length (mm) of the multilayer porous membrane in each direction was measured and the heat shrinkage factor was calculated by the following formula. Measurement was performed in the MD and TD, representing the heat shrinkage factors as the averages for each.

$$Heat shrinkage factor ( \% ) = \{ ( 50 - length after heating ) / 50 \} \times 100$$

### <180° Peel Strength (N/m)>

One side of a multilayer porous membrane piece cut out to 2 mm×7 mm, opposite the covering layer measured side, was attached to a glass plate using double-sided tape, and tape (product name: “Mending Tape MP-12” by 3M) was attached to the covering layer. A 5 mm portion at the tip of the tape was peeled off, and using a tensile tester (model AG-IS, SLBL-1kN by Shimadzu Corp.), one end of the tape was gripped with a chuck, peeling the tape at an angle of 180° with respect to the in-plane direction of the multilayer porous membrane. A tensile test was conducted with a pull rate of 50 mm/sec, a temperature of 25° C. and a relative humidity of 40%, for measurement of the tensile strength (N/m).

### <Glass Transition Temperature (° C.) of Thermoplastic Polymer>

A sufficient amount of the thermoplastic polymer coating solution (nonvolatile content=30%) was placed in an aluminum tray and dried for 30 minutes in a hot air drier at 130° C. About 17 mg of the dried film was packed into a measuring aluminum container, and the DSC curve and DDSC curve were obtained using a DSC measuring apparatus (DSC6220 by Shimadzu Corp.) under a nitrogen atmosphere. The measuring conditions were as follows.

### (First Stage Temperature Increase Program)

70° C. start, temperature increase at 15° C./minute. The temperature was maintained for 5 minutes after reaching 110° C.

### (Second Stage Temperature Decrease Program)

Temperature decrease from 110° C. at 40° C./minute. The temperature was maintained for 5 minutes after reaching −50° C.

### (Third Stage Temperature Increase Program)

Temperature increase from −50° C. to 130° C. at 15° C./minute. DSC and DDSC data recorded during third stage heating.

The intersection between the baseline (an extended straight line toward the high-temperature end from the baseline of the obtained DSC curve) and the tangent line at the inflection point (the point where the upwardly convex curve changed to a downwardly convex curve) was recorded as the glass transition temperature (Tg).

### <Dot Diameter and Dot Distance>

The dot diameter of the coating pattern of the thermoplastic polymer-containing coating solution was measured using a microscope (model: VHX-7000 by Keyence Corp.). The separator sample was photographed at 100× magnification (coaxial illumination), the diameters of multiple dots (5 points) were measured in measuring mode, calculating their average as the dot diameter. Using the distance from the outer edge section of a given dot to the outer edge section of the nearest adjacent dot as the “dot distance”, measurement was performed in measuring mode at 5 points, taking their average to calculate the dot distance.

### <Adhesion to Electrodes>

The multilayer porous membranes or separators obtained for each of the Examples and Comparative Examples, and negative electrodes (product of Enertech, negative electrode material: graphite, conductive aid: acetylene black, L/W: 20 mg/cm² for both sides, Cu current collector thickness: 10 μm, pressed negative electrode thickness: 140 μm) as adherends, were each cut out to rectangular shapes with widths of 15 mm and lengths of 60 mm, and were respectively stacked with the thermoplastic polymer-containing layer of the multilayer porous membrane or separator facing the negative electrode active material to obtain stacked bodies, which were then pressed under the following conditions.
Press pressure: 1 MPa
Temperature: 90° C.
Pressing time: 1 minute
   For each of the pressed stacked bodies, ZP5N and MX2-500N (product names) force gauges by Imada Co., Ltd. were used for a 900 peel test at a peel rate of 50 mm/min, with a pulling system in which the electrodes were anchored and the multilayer porous membrane or separator was held and pulled to measure the peel strength. The average for the peel strength in the peel test for 40 mm length, carried out under the conditions described above, was recorded as the adhesive force with the electrode. The adhesive force was measured before and after soaking the stacked body with propylene carbonate (PC), representing the adhesive force before PC impregnation as the Dry adhesive force and the adhesive force after PC impregnation as the Wet adhesive force. When a separator exhibiting adhesive force of preferably 1.0 N/m or greater and more preferably 1.8 N/m or greater according to this method is used in a nonaqueous electrolyte solution battery, the exhibited force of adhesion with the facing positive electrode and negative electrode is satisfactory. The adhesive force is preferably 100.0 N/m or lower from the viewpoint of ion resistance.
   <Pin Removal Property after Battery Winding>

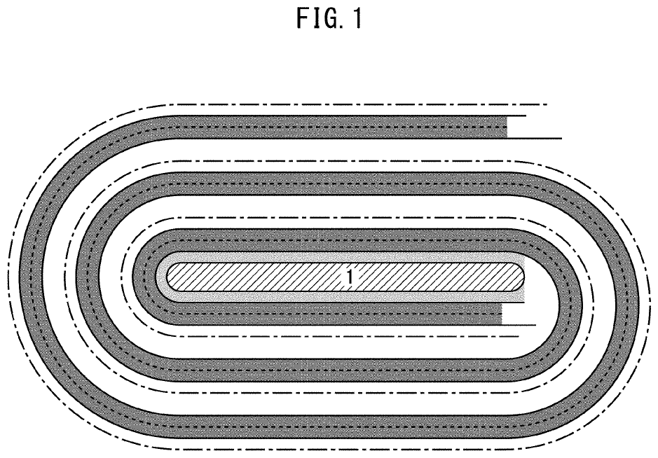

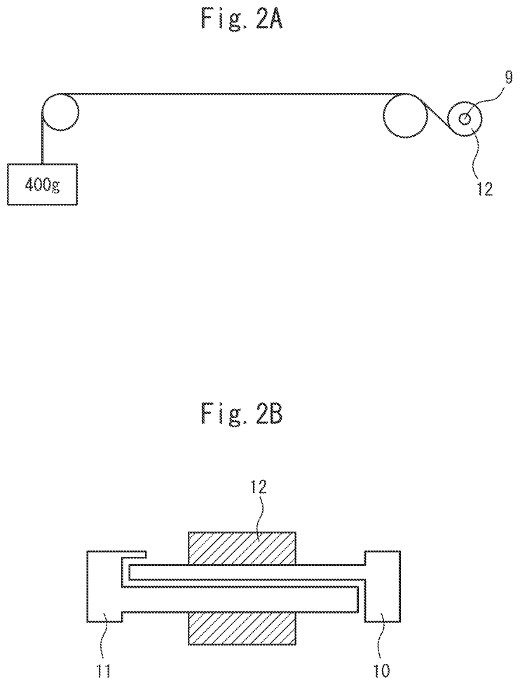

Using a manual winding machine by Kaido Mfg. Co., Ltd., the overall apparatus construction of which is shown in FIG. 2A, a winding sample (12) with a length of 3 m and a width of 60 mm as shown in FIG. 1 was prepared as a stack of 4 layers consisting of two separators, one positive electrode (positive electrode material: LiCoO₂, conductive aid: carbon black (Super-P Li), binder: PVDF, L/W: 36 mg/cm² on both sides, Al current collector thickness: 15 μm, 5.47 mAh/cm², product of Enertech Co.) and one negative electrode (negative electrode material: graphite, conductive aid: carbon black (Super-P Li), binder: PVDF, L/W: 20 mg/cm² on both sides, Cu current collector thickness: 10 μm, 5.75 mAh/cm², product of Enertech Co.), and was wound onto a pin (9) under a load of 400 g, and then as shown by the winding unit configuration in FIG. 2B, pin 1(10) was removed and the wound sample (12) manually detached from stretching pin II (11), evaluating the pin removal property based on the wound state of the sample after pin removal, on the following scale.
A (Good): No more than 1 of 100 samples showed shifting of 2 mm or greater of the pin contact section due to pulling of the pin, compared to before removal of the pin.
B (Poor): 2 to 4 of 100 samples showed shifting of 2 mm or greater of the pin contact section due to pulling of the pin, compared to before removal of the pin.
C (Very poor): 5 or more of 100 samples showed shifting of 2 mm or greater of the pin contact section due to pulling of the pin, compared to before removal of the pin.

### <Nail Penetration Test>

### (Fabrication of Positive Electrode)

There were uniformly mixed: a mixed positive electrode active material comprising lithium-nickel-manganese-cobalt composite oxide powder (LiNi_{1/3}Mn_{1/3}Co_{1/3}O₂) and lithium-manganese composite oxide powder (LiMn₂O₄), mechanically mixed at a weight ratio of 70:30, as a positive electrode active material: 85 parts by weight, acetylene black as a conductive aid: 6 parts by weight, and PVdF as a binder: 9 parts by weight, with N-methyl-2-pyrrolidone (NMP) as the solvent, to prepare a positive electrode mixture-containing paste. The positive electrode mixture-containing paste was evenly coated onto both sides of a 20 μm-thick current collector made of aluminum foil and dried, after which it was compression molded with a roll press, adjusting the thickness of the positive electrode mixture layer to a total thickness of 130 μm. A positive electrode was fabricated having a non-active material-coated aluminum foil with a length of 20 mm as a lead tab on a short side top section of a rectangular sheet with 95 mm short sides and 120 mm long sides.

### (Fabrication of Negative Electrode)

Graphite as a negative electrode active material: 91 parts by weight and PVdF as a binder: 9 parts by weight were mixed to uniformity with NMP as the solvent, to prepare a negative electrode mixture-containing paste. The negative electrode mixture-containing paste was evenly coated onto both sides of a 15 μm-thick current collector made of copper foil and dried, after which it was compression molded with a roll press, adjusting the thickness of the negative electrode mixture layer to a total thickness of 130 μm. A negative electrode was fabricated having a non-active material-coated copper foil with a length of 20 mm as a lead tab on a short side top section of a rectangular sheet with 95 mm short sides and 120 mm long sides.

### (Preparation of Nonaqueous Electrolyte Solution)

A nonaqueous electrolyte solution was prepared by dissolving 1.0 mol/liter concentration LiPF₆, as a solute, in a mixed solvent of ethylene carbonate:ethyl methyl carbonate:dimethyl carbonate=1:1:1 (volume ratio).

### (Fabrication of Cell)

An electrode plate stack was fabricated by alternately stacking 27 positive electrode sheets and 28 negative electrode sheets, each separated by a multilayer porous membrane as the separator. The separator was a separator strip with a width of 125 mm, which was alternately folded in a hairpin fashion to fabricate the electrode plate stack. After flat-pressing the electrode plate stack, it was housed in an aluminum laminate film and three of the sides were heat sealed. A positive electrode lead tab and negative electrode lead tab were each drawn out from one side of the laminate film. After drying, the nonaqueous electrolyte solution was injected into the three side-sealed laminate film and the remaining side was sealed. The laminated lithium ion secondary battery fabricated in this manner was designed for a capacity of 10 Ah.

### (Nail Penetration Evaluation)

The laminated lithium ion secondary battery was set on a steel sheet in a temperature-adjustable explosion-proof booth. Setting the explosion-proof booth interior to a temperature of 40° C., the center section of the laminated lithium ion secondary battery was punctured with an iron nail having a diameter of 3.0 mm at a speed of 2 mm/sec, and the nail was left in the punctured state. A thermocouple had been set inside the nail so as to allow measurement inside the laminated battery after puncturing with the nail, and its temperature was measured and the presence or absence of ignition and the maximum ultimate temperature were evaluated as follows.
A: No ignition, maximum ultimate temperature of <300° C.
B: No ignition, maximum ultimate temperature of ≥300° C.
C: Ignition after 15 seconds from start of the test
D: Ignition within 15 seconds from start of the test

### <Battery Evaluation>

(a. Fabrication of Positive Electrode)

A slurry was prepared by dispersing 91.2 parts by weight of lithium-nickel-manganese-cobalt composite oxide (Li[Ni_{1/3}Mn_{1/3}Co_{1/3}]O₂) as a positive electrode active material, 2.3 parts by weight each of scaly graphite and acetylene black as conductive materials, and 4.2 parts by weight of polyvinylidene fluoride (PVDF) as a resin binder, in N-methylpyrrolidone (NMP). The slurry was coated using a die coater onto one side of aluminum foil with a thickness of 20 μm as the positive electrode, to a positive electrode active material coating amount of 120 g/m². After 3 minutes of drying at 130° C., a roll press was used for compression molding to a positive electrode active material bulk density of 2.90 g/cm³, to produce a positive electrode. The positive electrode was punched out to a circle with an area of 2.00 cm².

(b. Fabrication of Negative Electrode)

A slurry was prepared by dispersing 96.6 parts by weight of artificial graphite as a negative electrode active material, 1.4 parts by weight of carboxymethyl cellulose ammonium salt as a resin binder and 1.7 parts by weight of styrene-butadiene copolymer latex, in purified water. The slurry was coated using a die coater onto one side of copper foil with a thickness of 16 μm as the negative electrode collector, to a negative electrode active material coating amount of 53 g/m². After 3 minutes of drying at 120° C., a roll press was used for compression molding to a negative electrode active material bulk density of 1.35 g/cm³, to produce a negative electrode. This was punched out to a circle with an area of 2.05 cm²

(c. Preparation of Nonaqueous Electrolyte Solution)

A 1.0 ml/L portion of concentrated LiPF₆, as a solute, was dissolved in a mixed solvent of ethylene carbonate:ethyl carbonate=1:2 (volume ratio), to prepare a nonaqueous electrolyte solution.

(d. Battery Assembly)

The negative electrode, multilayer porous membrane and positive electrode were stacked in that order from the bottom with the active material sides of the positive electrode and negative electrode facing each other. The stack was housed in a covered stainless steel metal container, with the container body and cover insulated, and with the copper foil of the negative electrode and the aluminum foil of the positive electrode each contacting with the container body and cover, to obtain a cell. The cell was dried under reduced pressure at 70° C. for 10 hours. A nonaqueous electrolyte solution was then injected into the container in an argon box and the cell was sealed as a cell for evaluation.

(e. Cycle Test)

Each battery assembled as described in (d. Battery assembly) above was subjected to initial charging after battery fabrication, for a total of approximately 6 hours, to a cell voltage of 4.2 V at a temperature of 25° C. and a current value of 3 mA (˜0.5 C), and initial drawing out of the current value from 3 mA while maintaining 4.2 V, and then to discharge up to a cell voltage of 3.0 V at a current value of 3 mA.

Next, the battery was subjected to charge for a total of approximately 3 hours, by a method of charge to a cell voltage of 4.2 V at a current value of 6 mA (˜1.0 C) at 25° C. and initial drawing out of the current value from 6 mA while maintaining 4.2 V, and then to discharge up to a cell voltage of 3.0 V at a current value of 6 mA, obtaining the service capacity at that time as the 1 C service capacity (mAh).

Next, the battery was subjected to charge for a total of approximately 3 hours, by a method of charge to a cell voltage of 4.2 V at a current value of 6 mA (˜1.0 C) at 25° C. and initial drawing out of the current value from 6 mA while maintaining 4.2 V, and then to discharge up to a cell voltage of 3.0 V at a current value of 60 mA (˜10 C), obtaining the service capacity at that time as the 10 C service capacity (mAh).

The battery was then discharged at a discharge current of 1 C to a final discharge voltage of 3 V at a temperature of 25° C., and then charged at a charging current of 1 C to a final charge voltage of 4.2 V. Charge-discharge was repeated with this procedure as 1 cycle. The capacity retention after 300 cycles with respect to the initial capacity (the capacity at the first cycle) was used to evaluate the cycle characteristic on the following scale.
A: Capacity retention of ≥83%.
B: Capacity retention of ≥80% and <83%.
C: Capacity retention of ≥75% and <80%.
D: Capacity retention of <75%.

### Example 1

A tumbler blender was used to form a polymer blend comprising 46.5 weight % of homopolymer polyethylene (PE) with a viscosity-average molecular weight (Mv) of 700,000, 46.5 weight % of homopolymer PE with an My of 250,000 and 7 weight % of homopolymer polypropylene (PP) with an My of 400,000. To 99 parts by weight of the polymer blend there was added 1 part by weight of pentaerythrityl-tetrakis-[3-(3,5-di-t-butyl-4-hydroxyphenyl)propionate] as an antioxidant, and a tumbler blender was again used for dry blending to obtain a polymer mixture. The obtained polymer mixture was substituted with nitrogen and then supplied to a twin-screw extruder using a feeder under a nitrogen atmosphere. Also, liquid paraffin (kinematic viscosity at 37.78° C.: 7.59×10⁻⁵ m²/s) was injected into the extruder cylinder by a plunger pump.

The mixture was melt kneaded with adjustment of the feeder and pump for a liquid paraffin quantity ratio of 68 weight % in the total extruded mixture (resin composition concentration of 32 weight %). The melt kneading conditions were a preset temperature of 200° C., a screw rotational speed of 70 rpm and a discharge throughput of 145 kg/h.

The melt kneaded mixture was then extrusion cast through a T-die onto a cooling roll controlled to a surface temperature of 25° C., to obtain a gel sheet with a thickness of 1350 μm.

The gel sheet was then simultaneously fed into a biaxial tenter stretching machine for biaxial stretching. The stretching conditions were an MD factor of 7.0, a TD factor of 6.38 and a preset temperature of 122° C. The sheet was subsequently fed into a methylene chloride tank and thoroughly immersed in the methylene chloride for extraction removal of the liquid paraffin, after which the methylene chloride was dried off to obtain a porous body.

The porous body was fed to a TD tenter and heat set. The heat setting temperature was 132° C., the maximum TD factor was 1.85 and the relaxation factor was 0.784, to obtain a polyolefin microporous membrane (PO microporous membrane A) with a thickness of 12.0 μm. The resin composition and measurement results for the obtained polyolefin microporous membrane are shown in Table 1.

Next, inorganic particles having the mean particle size (D₅₀), BET specific surface area and stress relaxation rate shown in Table 2 were used for mixture with a dispersing agent, water-soluble binder and water-insoluble binder resin binder as shown in Table 3 and further mixed with a suitable amount of water and sodium polycarboxylate (as solid content), after which the mixture was stirred and dispersed. When necessary, bead mill treatment was carried out under conditions with a bead diameter of 0.1 mm and a rotational speed of 2000 rpm inside the mill. Xantham gum was also added as a thickener to the treated liquid mixture when necessary, to prepare a coating solution.

The surface of the polyolefin microporous membrane was subjected to corona discharge treatment, after which a gravure coater was used to coat the treated surface with the coating solution. After then drying the coating solution on the polyolefin microporous membrane at 60° C. to remove the water, a porous layer with a thickness of 1.5 μm comprising 97.5 weight % (90.6 vol %) of inorganic particles was formed on one side of the polyolefin microporous membrane to obtain a multilayer porous membrane. Table 3 shows the membrane properties of the obtained multilayer porous membrane, and the evaluation results of a battery comprising the multilayer porous membrane as a separator.

### Examples 2 to 13 and Comparative Examples 1 to 6

Multilayer porous membranes were formed in the same manner as Example 1, except that the production conditions and physical properties of the polyolefin microporous membranes, and the types of inorganic particles, the types of constituent components of the porous layer, the coating solution compositions and the coating conditions, were set as shown in Tables 1 to 3. The properties of the obtained multilayer porous membrane and a battery comprising it as a separator were evaluated by the method described above. The evaluation results are shown in Table 3.

For Examples 12 and 13, after mixing 80 parts by weight of an adhesive resin (acrylic polymer, glass transition temperature: 90° C., mean particle size: 380 nm, electrolyte solution swelling degree: 2.8) and 20 parts by weight of an adhesive resin with a different glass transition temperature (acrylic polymer, glass transition temperature: −6° C., mean particle size: 132 nm, electrolyte solution swelling degree: 2.5), ion-exchanged water was added to prepare an adhesive resin-containing coating solution (adhesive resin concentration: 3 weight %). The porous layer, or one side of the polyolefin microporous membrane with the porous layer, was coated in a dotted manner with the adhesive resin-containing coating solution using a gravure coater, to form a dot pattern having the dot diameters and dot distances shown in Table 3. It was then dried at 60° C. to remove the water.

TABLE 1

| PO microporous | | PO microporous | PO microporous | PO microporous | PO microporous |
|---|---|---|---|---|---|
| membrane | — | membrane A | membrane B | membrane C | membrane D |
| Polyethylene | weight % | 93 | 100 | 95 | 93 |
| percentage | | | | | |
| Polypropylene | weight % | 7 | 0 | 5 | 7 |
| percentage | | | | | |
| MI | g/10 min | 0.47 | 0.15 | 0.60 | 0.80 |
| Film thickness TB | μm | 12.0 | 7.0 | 4.5 | 6.0 |
| Porosity | % | 42 | 42 | 40 | 34 |
| Air permeability | sec/100 | 150 | 90 | 80 | 153 |
| | cm³ | | | | |
| Puncture strength | gf | 500 | 380 | 200 | 180 |
| Puncture strength | N | 4.90 | 3.72 | 1.96 | 1.76 |
| Basis weight- | gf/(g/m²) | 76 | 99 | 78 | 48 |
| equivalent | | | | | |
| strength | | | | | |
| Basis weight- | N/(g/m²) | 0.74 | 0.97 | 0.76 | 0.47 |
| equivalent | | | | | |
| strength | | | | | |

TABLE 2

| | | Barium | Barium | Barium | Barium | Barium | Barium | Barium | | |
|---|---|---|---|---|---|---|---|---|---|---|
| Inorganic | | sulfate | sulfate | sulfate | sulfate | sulfate | sulfate | sulfate | Boehmite | Boehmite |
| particles | — | A | B | C | D | E | F | G | A | B |
| D50 | μm | 0.33 | 0.45 | 0.29 | 0.31 | 0.62 | 0.60 | 0.40 | 0.46 | 0.27 |
| particle | | | | | | | | | | |
| size | | | | | | | | | | |
| BET | m²/g | 6.31 | 5.91 | 12.00 | 13.50 | 3.00 | 2.80 | 6.50 | 7.00 | 14.00 |
| specific | | | | | | | | | | |
| surface | | | | | | | | | | |
| area | | | | | | | | | | |
| Stress | % | 8.8 | 8.2 | 12.2 | 17.9 | 9.5 | 18.5 | 18.2 | 22.6 | 24.0 |
| relaxation | | | | | | | | | | |
| rate in | | | | | | | | | | |
| shear | | | | | | | | | | |
| testing | | | | | | | | | | |

TABLE 3

| | | | Example 1 | Example 2 | Example 3 | Example 4 | Example 5 |
|---|---|---|---|---|---|---|---|
| Substrate | PO microporous membrane | — | PO | PO | PO | PO | PO |
| information | | | microporous | microporous | microporous | microporous | microporous |
| | | | membrane A | membrane A | membrane A | membrane A | membrane A |
| Constituent | Inorganic particles | — | Barium | Barium | Barium | Barium | Barium |
| features of | | | sulfate C | sulfate C | sulfate A | sulfate A | sulfate A |
| porous | Inorganic particle size | μm | 0.29 | 0.29 | 0.33 | 0.33 | 0.33 |
| layer | Inorganic particle weight ratio | weight % | 97.5 | 97.5 | 97.7 | 97.7 | 97.7 |
| | Inorganic particle volume ratio | vol % | 90.6 | 91.0 | 91.0 | 91.5 | 91.1 |
| | Dispersing agent weight ratio | weight % | 0.6 | 0.6 | 0.4 | 0.4 | 0.4 |
| | Water-soluble binder type | — | Poly(meth) | Poly(meth) | CMC | Poly(meth) | CMC |
| | | | acrylamide | acrylamide | | acrylamide | |
| | Water-soluble binder weight | weight % | 0.2 | 1.5 | 1.0 | 1.0 | 0.2 |
| | ratio Wa | | | | | | |
| | Water-insoluble binder type | — | Acrylic latex | Acrylic latex | Acrylic latex | Acrylic latex | Acrylic latex |
| | Water-insoluble binder weight | weight % | 1.8 | 0.5 | 1.0 | 1.0 | 1.8 |
| | ratio Wb | | | | | | |
| | Wb/Wa | — | 9.0 | 0.3 | 1.0 | 1.0 | 9.0 |
| Physical | Static friction coefficient MD | — | 0.27 | 0.28 | 0.26 | 0.26 | 0.26 |
| properties | Static friction coefficient TD | — | 0.28 | 0.28 | 0.26 | 0.25 | 0.26 |
| of porous | Dynamic friction coefficient MD | — | 0.27 | 0.27 | 0.25 | 0.25 | 0.26 |
| layer A | Dynamic friction coefficient TD | — | 0.27 | 0.27 | 0.25 | 0.26 | 0.26 |
| | Static friction coefficient/ | — | 1.00 | 1.04 | 1.04 | 1.04 | 1.00 |
| | dynamic friction coefficient MD | | | | | | |
| | Porous layer A thickness T | μm | 1.5 | 1.5 | 1.4 | 1.4 | 1.7 |
| | Porous layer air permeability | sec/ | 16.0 | 17.0 | 13.0 | 15.0 | 18.0 |
| | | 100 cm³ | | | | | |
| | Air permeability per unit | (sec/100 | 10.7 | 11.3 | 9.3 | 10.7 | 10.6 |
| | thickness | cm³)/um | | | | | |
| | Porous layer density | (g/m²)/μm | 2.6 | 2.6 | 2.7 | 2.7 | 2.8 |
| Porous | Porous layer B thickness | μm | 0.0 | 0.0 | 0.0 | 0.0 | 0.0 |
| layer B | | | | | | | |
| | | | Example 6 | Example 7 | Example 8 | Example 9 | Example 10 |
| Substrate | PO microporous membrane | — | PO | PO | PO | PO | PO |
| information | | | microporous | microporous | microporous | microporous | microporous |
| | | | membrane A | membrane A | membrane B | membrane C | membrane B |
| Constituent | Inorganic particles | — | Barium | Barium | Barium | Barium | Barium |
| features of | | | sulfate A | sulfate B | sulfate A | sulfate A | sulfate A |
| porous | Inorganic particle size | μm | 0.33 | 0.45 | 0.33 | 0.33 | 0.33 |
| layer | Inorganic particle weight ratio | weight % | 97.7 | 97.4 | 97.7 | 97.7 | 97.7 |
| | Inorganic particle volume ratio | vol % | 91.7 | 90.1 | 91.5 | 91.5 | 91.5 |
| | Dispersing agent weight ratio | weight % | 0.4 | 0.7 | 0.4 | 0.4 | 0.4 |
| | Water-soluble binder type | — | Poly(meth) | CMC | Poly(meth) | Poly(meth) | Poly(meth) |
| | | | acrylamide | | acrylamide | acrylamide | acrylamide |
| | Water-soluble binder weight | weight % | 2.0 | 1.0 | 1.0 | 1.0 | 1.0 |
| | ratio Wa | | | | | | |
| | Water-insoluble binder type | — | Acrylic latex | Acrylic latex | Acrylic latex | Acrylic latex | Acrylic latex |
| | Water-insoluble binder weight | weight % | 0.0 | 1.0 | 1.0 | 1.0 | 1.0 |
| | ratio Wb | | | | | | |
| | Wb/Wa | — | 0.0 | 1.0 | 1.0 | 1.0 | 1.0 |
| Physical | Static friction coefficient MD | — | 0.26 | 0.24 | 0.26 | 0.26 | 0.26 |
| properties | Static friction coefficient TD | — | 0.26 | 0.24 | 0.25 | 0.25 | 0.25 |
| of porous | Dynamic friction coefficient MD | — | 0.25 | 0.23 | 0.25 | 0.25 | 0.26 |
| layer A | Dynamic friction coefficient TD | — | 0.25 | 0.23 | 0.25 | 0.26 | 0.26 |
| | Static friction coefficient/ | — | 1.04 | 1.04 | 1.04 | 1.04 | 1.00 |
| | dynamic friction coefficient MD | | | | | | |
| | Porous layer A thickness T | μm | 1.5 | 1.5 | 1.5 | 1.0 | 1.0 |
| | Porous layer air permeability | sec/ | 17.0 | 15.0 | 16.0 | 11.0 | 11.0 |
| | | 100 cm³ | | | | | |
| | Air permeability per unit | (sec/100 | 11.3 | 10.0 | 10.7 | 11.0 | 11.0 |
| | thickness | cm³)/um | | | | | |
| | Porous layer density | (g/m²)/um | 2.6 | 2.5 | 2.7 | 2.7 | 2.7 |
| Porous | Porous layer B thickness | Um | 0.0 | 0.0 | 0.0 | 0.0 | 1.0 |
| layer B | | | | | | | |
| | | | | | | Comp. | Comp. |
| | | | Example 11 | Example 12 | Example 13 | Example 1 | Example 2 |
| Substrate | PO microporous membrane | — | PO | PO | PO | PO | PO |
| information | | | microporous | microporous | microporous | microporous | microporous |
| | | | membrane D | membrane B | membrane B | membrane A | membrane A |
| Constituent | Inorganic particles | — | Barium | Barium | Barium | Barium | Barium |
| features of | | | sulfate A | sulfate A | sulfate A | sulfate D | sulfate E |
| porous | Inorganic particle size | μm | 0.33 | 0.33 | 0.33 | 0.31 | 0.62 |
| layer | Inorganic particle weight ratio | weight % | 97.7 | 97.7 | 97.7 | 97.4 | 97.4 |
| | Inorganic particle volume ratio | vol % | 91.5 | 91.5 | 91.5 | 90.7 | 90.4 |
| | Dispersing agent weight ratio | weight % | 0.4 | 0.4 | 0.4 | 0.7 | 0.7 |
| | Water-soluble binder type | — | Poly(meth) | Poly(meth) | Poly(meth) | Poly(meth) | Poly(meth) |
| | | | acrylamide | acrylamide | acrylamide | acrylamide | acrylamide |
| | Water-soluble binder weight | weight % | 1.0 | 1.0 | 1.0 | 1.5 | 0.5 |
| | ratio Wa | | | | | | |
| | Water-insoluble binder type | — | Acrylic latex | Acrylic latex | Acrylic latex | Acrylic latex | Acrylic latex |
| | Water-insoluble binder weight | weight % | 1.0 | 1.0 | 1.0 | 0.5 | 1.5 |
| | ratio Wb | | | | | | |
| | Wb/Wa | — | 1.0 | 1.0 | 1.0 | 0.3 | 3.0 |
| Physical | Static friction coefficient MD | — | 0.26 | 0.26 | 0.26 | 0.42 | 0.22 |
| properties | Static friction coefficient TD | — | 0.25 | 0.25 | 0.25 | 0.42 | 0.20 |
| of porous | Dynamic friction coefficient MD | — | 0.25 | 0.25 | 0.25 | 0.39 | 0.22 |
| layer A | Dynamic friction coefficient TD | — | 0.25 | 0.25 | 0.25 | 0.39 | 0.22 |
| | Static friction coefficient/ | — | 1.04 | 1.04 | 1.04 | 1.08 | 1.00 |
| | dynamic friction coefficient MD | | | | | | |
| | Porous layer A thickness T | μm | 1.5 | 1.5 | 1.5 | 1.5 | 1.5 |
| | Porous layer air permeability | sec/ | 16.0 | 16.0 | 16.0 | 10.0 | 17.0 |
| | | 100 cm³ | | | | | |
| | Air permeability per unit | (sec/100 | 10.7 | 10.7 | 10.7 | 6.7 | 11.3 |
| | thickness | cm³)/um | | | | | |
| | Porous layer density | (g/m²)/um | 2.7 | 2.7 | 2.7 | 2.1 | 2.4 |
| Porous | Porous layer B thickness | μm | 0.0 | 0.0 | 0.0 | 0.0 | 0.0 |
| layer B | | | | | | | |

| | | | Comp. | Comp. | Comp. | Comp. |
|---|---|---|---|---|---|---|
| | | | Example 3 | Example 4 | Example 5 | Example 6 |
| Substrate | PO microporous membrane | — | PO microporous | PO microporous | PO microporous | PO microporous |
| information | | | membrane A | membrane A | membrane A | membrane A |
| Constituent | Inorganic particles | — | Boehmite A | Boehmite B | Barium | Barium |
| features of | | | | | sulfate F | sulfate G |
| porous | Inorganic particle size | μm | 0.46 | 0.27 | 0.60 | 0.40 |
| layer | Inorganic particle weight ratio | weight % | 95.8 | 95.8 | 97.0 | 95.7 |
| | Inorganic particle volume ratio | vol % | 89.1 | 89.1 | 88.9 | 85.1 |
| | Dispersing agent weight ratio | weight % | 0.6 | 0.6 | 0.6 | 1.0 |
| | Water-soluble binder type | — | CMC | CMC | CMC | Poly(meth) |
| | | | | | | acrylamide |
| | Water-soluble binder weight | weight % | 0.3 | 0.3 | 0.0 | 1.4 |
| | ratio Wa | | | | | |
| | Water-insoluble binder type | — | Acrylic latex | Acrylic latex | Acrylic latex | Acrylic latex |
| | Water-insoluble binder weight | weight % | 3.4 | 3.4 | 2.4 | 1.9 |
| | ratio Wb | | | | | |
| | Wb/Wa | — | 11.7 | 11.7 | — | 1.3 |
| Physical | Static friction coefficient MD | — | 0.41 | 0.43 | 0.42 | 0.41 |
| properties | Static friction coefficient TD | — | 0.41 | 0.42 | 0.41 | 0.41 |
| of porous | Dynamic friction coefficient MD | — | 0.30 | 0.37 | 0.39 | 0.38 |
| layer A | Dynamic friction coefficient TD | — | 0.30 | 0.36 | 0.38 | 0.38 |
| | Static friction coefficient/ | — | 1.37 | 1.16 | 1.08 | 1.08 |
| | dynamic friction coefficient MD | | | | | |
| | Porous layer A thickness T | μm | 1.5 | 2.0 | 1.1 | 3.0 |
| | Porous layer air permeability | sec/ | 10.0 | 9.0 | 3.3 | 27.0 |
| | | 100 cm³ | | | | |
| | Air permeability per unit | (sec/100 | 6.7 | 4.5 | 3.0 | 9.0 |
| | thickness | cm³)/um | | | | |
| | Porous layer density | (g/m²)/um | 1.7 | 1.5 | 2.3 | 2.3 |
| Porous | Porous layer B thickness | μm | 0.0 | 0.0 | 0.0 | 0.0 |
| layer B | | | | | | |

| | | | Example 1 | Example 2 | Example 3 | Example 4 | Example 5 |
|---|---|---|---|---|---|---|---|
| Physical | Thickness | μm | 13.5 | 13.5 | 13.4 | 13.4 | 13.7 |
| properties of | T/TB | — | 0.13 | 0.13 | 0.12 | 0.12 | 0.14 |
| multilayer | Air permeability | sec/ | 166 | 167 | 163 | 165 | 168 |
| porous | | 100 cm³ | | | | | |
| membrane | Air permeability increase | — | 0.11 | 0.11 | 0.09 | 0.10 | 0.12 |
| | Puncture strength | gf | 500 | 500 | 500 | 500 | 500 |
| | Puncture strength | N | 4.90 | 4.90 | 4.90 | 4.90 | 4.90 |
| | 130° C.-Dry heat shrinkage MD | % | 2 | 2 | 1 | 1 | 1 |
| | 130° C.-Dry heat shrinkage TD | % | 2 | 3 | 1 | 1 | 1 |
| | 150° C.-Dry heat shrinkage MD | % | 3 | 2 | 3 | 3 | 4 |
| | 150° C.-Dry heat shrinkage TD | % | 3 | 2 | 5 | 4 | 3 |
| | 140° C.-Wet heat shrinkage MD | % | — | — | — | 4 | — |
| | 140° C.-Wet heat shrinkage TD | % | — | — | — | 4 | — |
| | 180° peel strength | N/m | 317 | 429 | 335 | 360 | 301 |
| Physical | Dot diameter | μm | — | — | — | — | — |
| properties | Dot distance | μm | — | — | — | — | — |
| of adhesive | Dry adhesive force (facing | N/m | — | — | — | — | — |
| layer | negative electrode) | | | | | | |
| | Wet adhesive force (facing | N/m | — | — | — | — | — |
| | negative electrode) | | | | | | |
| Battery | Pin removal property | — | B | B | A | A | A |
| evaluation | Nail penetration test | — | B | A | B | A | B |
| | Cycle test | — | B | B | B | B | B |
| | | | Example 6 | Example 7 | Example 8 | Example 9 | Example 10 |
| Physical | Thickness | μm | 13.5 | 13.5 | 8.5 | 5.5 | 9.0 |
| properties of | T/TB | — | 0.13 | 0.13 | 0.21 | 0.22 | 0.14 |
| multilayer | Air permeability | sec/ | 167 | 165 | 106 | 91 | 101 |
| porous | | 100 cm³ | | | | | |
| membrane | Air permeability increase | — | 0.11 | 0.10 | 0.18 | 0.14 | 0.12 |
| | Puncture strength | gf | 500 | 500 | 380 | 200 | 380 |
| | Puncture strength | N | 4.90 | 4.90 | 3.72 | 1.96 | 3.72 |
| | 130° C.-Dry heat shrinkage MD | % | 1 | 2 | 1 | 1 | 1 |
| | 130° C.-Dry heat shrinkage TD | % | 1 | 2 | 1 | 1 | 1 |
| | 150° C.-Dry heat shrinkage MD | % | 1 | 17 | 3 | 3 | 3 |
| | 150° C.-Dry heat shrinkage TD | % | 1 | 23 | 3 | 3 | 3 |
| | 140° C.-Wet heat shrinkage MD | % | — | — | — | — | — |
| | 140° C.-Wet heat shrinkage TD | % | — | — | — | — | — |
| | 180° peel strength | N/m | 436 | 304 | 355 | 358 | 361 |
| Physical | Dot diameter | μm | — | — | — | — | — |
| properties | Dot distance | μm | — | — | — | — | — |
| of adhesive | Dry adhesive force (facing | N/m | — | — | — | — | — |
| layer | negative electrode) | | | | | | |
| | Wet adhesive force (facing | N/m | — | — | — | — | — |
| | negative electrode) | | | | | | |
| Battery | Pin removal property | — | A | A | A | A | A |
| evaluation | Nail penetration test | — | A | A | A | B | A |
| | Cycle test | — | B | B | A | A | A |
| | | | | | | Comp. | Comp. |
| | | | Example 11 | Example 12 | Example 13 | Example 1 | Example 2 |
| Physical | Thickness | μm | 7.5 | 8.5 | 8.5 | 13.5 | 13.5 |
| properties of | T/TB | — | 0.25 | 0.21 | 0.21 | 0.13 | 0.13 |
| multilayer | Air permeability | sec/ | 169 | 106 | 106 | 160 | 167 |
| porous | | 100 cm³ | | | | | |
| membrane | Air permeability increase | — | 0.10 | 0.18 | 0.18 | 0.07 | 0.11 |
| | Puncture strength | gf | 180 | 380 | 380 | 500 | 500 |
| | Puncture strength | N | 1.76 | 3.72 | 3.72 | 4.90 | 4.90 |
| | 130° C.-Dry heat shrinkage MD | % | 1 | 1 | 1 | 3 | 4 |
| | 130° C.-Dry heat shrinkage TD | % | 1 | 1 | 1 | 3 | 4 |
| | 150° C.-Dry heat shrinkage MD | % | 3 | 3 | 3 | 55 | 56 |
| | 150° C.-Dry heat shrinkage TD | % | 3 | 3 | 3 | 57 | 58 |
| | 140° C.-Wet heat shrinkage MD | % | — | — | — | — | — |
| | 140° C.-Wet heat shrinkage TD | % | — | — | — | — | — |
| | 180° peel strength | N/m | 358 | 355 | 355 | 362 | 268 |
| Physical | Dot diameter | μm | — | 50 | 200 | — | — |
| properties | Dot distance | μm | — | 150 | 800 | — | — |
| of adhesive | Dry adhesive force (facing | N/m | — | 2.1 | 2.0 | — | — |
| layer | negative electrode) | | | | | | |
| | Wet adhesive force (facing | N/m | — | 2.2 | 2.1 | — | — |
| | negative electrode) | | | | | | |
| Battery | Pin removal property | — | A | A | A | C | A |
| evaluation | Nail penetration test | — | C | A | A | C | C |
| | Cycle test | — | B | A | A | C | B |

| | | | Comp. | Comp. | Comp. | Comp. |
|---|---|---|---|---|---|---|
| | | | Example 3 | Example 4 | Example 5 | Example 6 |
| Physical | Thickness | μm | 13.5 | 14.0 | 13.1 | 15.0 |
| properties of | T/TB | — | 0.13 | 0.17 | 0.09 | 0.25 |
| multilayer | Air permeability | sec/ | 160 | 159 | 153 | 177 |
| porous | | 100 cm³ | | | | |
| membrane | Air permeability increase | — | 0.07 | 0.06 | 0.02 | 0.18 |
| | Puncture strength | gf | 500 | 500 | 500 | 500 |
| | Puncture strength | N | 4.90 | 4.90 | 4.90 | 4.90 |
| | 130° C.-Dry heat shrinkage MD | % | 1 | 2 | 8 | 2 |
| | 130° C.-Dry heat shrinkage TD | % | 1 | 3 | 7 | 2 |
| | 150° C.-Dry heat shrinkage MD | % | 19 | 40 | 56 | 3 |
| | 150° C.-Dry heat shrinkage TD | % | 25 | 64 | 57 | 3 |
| | 140° C.-Wet heat shrinkage MD | % | — | — | — | — |
| | 140° C.-Wet heat shrinkage TD | % | — | — | — | — |
| | 180° peel strength | N/m | 276 | 195 | 300 | 379 |
| Physical | Dot diameter | μm | — | — | — | — |
| properties | Dot distance | μm | — | — | — | — |
| of adhesive | Dry adhesive force (facing | N/m | — | — | — | — |
| layer | negative electrode) | | | | | |
| | Wet adhesive force (facing | N/m | — | — | — | — |
| | negative electrode) | | | | | |
| Battery | Pin removal property | — | C | C | C | C |
| evaluation | Nail penetration test | — | C | C | C | A |
| | Cycle test | — | B | B | B | D |

### REFERENCE SIGNS LIST

Solid line: separator
Dotted line: positive electrode
Dash-dot line: negative electrode
1 Flat pin
9 Pin
10 Pin I
11 Pin II
12 Winding sample

1: A multilayer porous membrane having:
a microporous membrane comprising a polyolefin resin as a main component; and
a porous layer comprising inorganic particles, layered on at least one side of the microporous membrane, wherein:
a mean particle size D₅₀ of the inorganic particles is 0.01 μm or greater and smaller than 0.60 μm,
a weight ratio of the inorganic particles in the porous layer is greater than 80%,
a volume ratio of the inorganic particles in the porous layer is greater than 70%,
a surface static friction coefficient of the porous layer is 0.01 to 0.40, and
a surface dynamic friction coefficient of the porous layer is 0.01 to 0.35.

2: The multilayer porous membrane according to claim 1, wherein an air permeability of the multilayer porous membrane is 400 sec/100 cm³ or lower.

3: The multilayer porous membrane according to claim 1, wherein a basis weight-equivalent puncture strength of the microporous membrane is 0.49 N/(g/m²) or greater.

4: The multilayer porous membrane according to claim 1, wherein a thickness of the porous layer is 4 μm or smaller on at least one side of the microporous membrane.

5: The multilayer porous membrane according to claim 1, wherein an air permeability of the porous layer is 100 sec/100 cm³ or lower.

6: The multilayer porous membrane according to claim 1, wherein a ratio (surface static friction coefficient/surface dynamic friction coefficient) of the surface static friction coefficient with respect to the surface dynamic friction coefficient is 1.07 or lower.

7: The multilayer porous membrane according to claim 1, wherein a heat shrinkage factor of the multilayer porous membrane at 150° C. is 10% or lower in both the MD direction and TD direction.

8: The multilayer porous membrane according to claim 1, wherein the multilayer porous membrane is a separator for a nonaqueous electrolyte solution battery.

9: A nonaqueous electrolyte solution battery comprising a positive electrode, the multilayer porous membrane according to claim 8, a negative electrode and a nonaqueous electrolyte solution.
